(19) United States
(12) Patent Application Publication
(10) Pub. No.: US 2010/0235724 A1
(43) Pub. Date: Sep. 16, 2010

(54) INFORMATION PROCESSING APPARATUS, IMAGE DATA GENERATION METHOD, AND COMPUTER-READABLE STORAGE MEDIUM

(75) Inventor: Hiroki Koyano, Sagamihara-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/719,399

(22) Filed: Mar. 8, 2010

(30) Foreign Application Priority Data
Mar. 10, 2009 (JP) 2009-056757

(51) Int. Cl. G06F 3/14

(52) U.S. Cl. 715/221

(57) ABSTRACT

An apparatus changes at least one of a size of variable graphics, a position of the variable graphics, and a size of a print area in such a way as to eliminate an overlap between the variable graphics and other graphics. To reduce the size of the variable graphics, the apparatus can reduce a thickness of an outer frame line of the variable graphics or reduce a height of a heading row of the variable graphics. Further, the apparatus can replace data, if the row height of the variable graphics is increased when the data is combined with the variable graphics, with another data. The apparatus can display original data in another area.

### BACKGROUND OF THE INVENTION

1. Field of the Invention

The present invention relates to an information processing apparatus, an image data generation method, and a computer program. More specifically, the present invention relates to a technique capable of generating image data by adding field data in an area set beforehand in a form.

2. Description of the Related Art

There is a conventional print processing (overlay printing) apparatus that can combine field data of text format (i.e., field data file) with a form (form information file) generated by a form generation apparatus. The size of a corporate work system is increasing. There are various types of forms, including “estimate form” and “application form”, which are used in the print job. The amount of data corresponding to these forms is increasing correspondingly. Therefore, in view of the maintenance and management for the above-described forms and the costs for the print processing, the following requirements are raised.

There is a conventional technique for improving the diversion rate of each form by frequently using the form in a work system that performs the overlay printing. More specifically, the technique includes generating a “component form” including characters and graphics, which are frequently used, for each job or for each division in a company and then combining a plurality of “component forms” to generate a “composite form” to be processed for the print processing.

FIG. 27 illustrates an example of a composite form file that can be generated by combining a plurality of component forms (i.e., form information files). As illustrated in FIG. 27, for example, in a case where a statement of delivery is generated as a composite form file 2704, the portions that can be commonly used in a plurality of forms, such as a caption portion 2701 and a stationary characters/graphics portion 2703, are generated beforehand as independent component forms (i.e., form information files). Then, the composite form file 2704 can be generated by superposing the above-described component forms (i.e., the caption portion 2701 and the stationary characters/graphics portion 2703) with a table graphics form 2702 having a format that is variable in row height according to the data amount. In the following description, the table graphics having the format that is variable in row height depending on the data amount can be referred to, if necessary, as “row height variable table graphics” or “variable graphics.”

FIG. 28 illustrates an example of a composite form setting screen (GUI) that can be displayed when a user selects component forms to be used. To generate the above-described composite form file 2704, a user can designate component forms to be added on a composite form setting screen 2801 illustrated in FIG. 28. In this case, an image of the composite form file generated based on a plurality of component forms can be displayed on the composite form setting screen 2801.

However, the following problems may arise when a composite form file including a component form in which variable graphics is defined is subjected to the overlay printing. More specifically, the variable graphics may partly expand in row height (i.e., the height of a row) depending on designated field data, compared to the original row height of the variable graphics. As a result, the variable graphics may cause an undesirable overlap with graphics defined in other component form.

FIG. 29 illustrates an example of the variable graphics and other graphics that are overlapped with each other, as a result of the overlay printing that partly increases the size of the variable graphics. In FIG. 29, when field data 2902 corresponding to the variable graphics is stored in a composite form 2901, the row height of the final row is increased because the data stored in a special mention field in the final row of the field data 2902 is large in size compared to the original final row. Therefore, a finishing image 2903 obtained by performing the overlay printing includes variable graphics 2904 and other graphics 2905 that are overlapped with each other.

To solve this problem, as discussed in Japanese Patent Application Laid-Open No. 2008-129702, there is a conventional technique capable of performing print processing using a layout configuration that does not cause any overlap between two or more graphics regardless of the amount of designated data.

However, according to the above-described conventional techniques, there is not any effective method for enabling users to easily and promptly recognize an undesirable overlap between the variable graphics and other graphics that may occur if the overlay print processing is executed. Namely, according to the above-described conventional techniques, the size of variable graphics to be generated on each page by the overlay print processing is dependent on the field data designated by each user.

Accordingly, to prevent the above-described overlap of a plurality of graphics, users are required to perform adjustment and setting for the overlay printing by repetitively performing reediting and print confirmation (preview) of each component form that constitutes a composite form file. Therefore, a work load on the user is increased and the work efficiently is worsened. Especially, when field data of many pages is designated, it becomes very difficult to confirm the print status of each page. Further, even when the above-described overlap between two or more graphics can be solved by redesigning each component form, the following problems may arise. More specifically, the configuration of each component form in an image obtained by the overlay printing may change greatly compared to the configuration of the original form. The diversion rate of each component form may deteriorate or the maintenance/management costs may increase.

### SUMMARY OF THE INVENTION

According to an aspect of the present invention, an apparatus includes a generation unit configured to generate a composite form based on a plurality of component forms so as to include at least one component form that can be combined with field data; a combining unit configured to combine field data with the component form; a first change unit configured to change a size of the component form based on the field data; a change amount calculation unit configured to, in a case where the size of the component form is changed and the changed component form is overlapped with any one of the plurality of component forms included in the composite form, calculate a change amount of a layout of the composite form to be realized according to each method if there are a plurality of methods for changing the layout of the composite form in such a way as to eliminate the overlap; a determination unit configured to select a method to be executed among the plurality of methods based on the change amount to be realized by each of the plurality kinds of methods calculated by the change amount calculation unit; and a second change unit configured to change the layout in such a way as to eliminate the overlap by executing the method selected by the determination unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a configuration of a computer system.

FIG. 2 is a block diagram illustrating an example of a configuration of a form information setting system.

FIG. 3 is a block diagram illustrating an example of a configuration of an overlay printing system.

FIG. 4 is a flowchart illustrating an example of page control setting processing.

FIG. 5 illustrates an example of a dialog that can be used to perform page control settings for variable graphics.

FIG. 6 illustrates an example of a dialog that enables users to set an effective print area of a sheet.

FIG. 7 illustrates an example of a dialog that enables users to set a height of a heading row.

FIG. 8 illustrates an example of a dialog that enables users to set a movement amount of the variable graphics.

FIG. 9 illustrates an example of a dialog that enables users to set a line width of the outer frame of the variable graphics.

FIG. 10 illustrates an example of a dialog that enables users to set details of field graphics.

FIG. 11 is a flowchart illustrating an example of a processing procedure for the overlay print processing.

FIG. 12 is a flowchart illustrating an example of the processing to be performed in step S1116 illustrated in FIG. 11.

FIG. 13 is a flowchart illustrating an example of a processing procedure for expanding an effective print area of a sheet.

FIG. 14 illustrates a change in the layout between before and after page control processing for expanding the effective print area of the sheet.

FIG. 15 is a flowchart illustrating an example of a processing procedure for reducing the height of a heading row.

FIG. 16 illustrates a change in the layout between before and after page control processing for reducing the height of the heading row of the variable graphics.

FIG. 17 is a flowchart illustrating an example of a processing procedure for moving the variable graphics.

FIG. 18 illustrates a change in the layout between before and after page control processing for moving the variable graphics.

FIG. 19 is a flowchart illustrating an example of a processing procedure for changing the line width of an outer frame line of the variable graphics.

FIG. 20 illustrates a change in the layout between before and after page control processing for changing the line width of the outer frame line of the variable graphics.

FIG. 21 is a flowchart illustrating an example of a processing procedure for replacing data in an enlarged portion where the row height becomes larger than the original row height with other data having a smaller data size that can be accommodated in the original row height and generating field graphics for storing the original data.

FIG. 22 is a flowchart illustrating a change in the layout between before and after page control processing for replacing data in an enlarged portion where the row height becomes larger than the original row height with other data having a smaller data size that can be accommodated in the original row height and generating field graphics for storing the original data.

FIG. 23 is a flowchart illustrating an example of processing to be performed by the overlay printing system that automatically performs the page control processing according to an optimum priority order for the page control processing, which is determined based on an overlap amount between the variable graphics and other graphics.

FIG. 24 illustrates an example of change amounts calculated in step S2301 illustrated in FIG. 23.

FIGS. 25A and 25B illustrate an example of a method for determining the order in the page control processing.

FIG. 26 illustrates an example of a dialog that enables users to select page control processing items to be executed.

FIG. 27 illustrates an example of a composite form file that can be generated by combining a plurality of component forms.

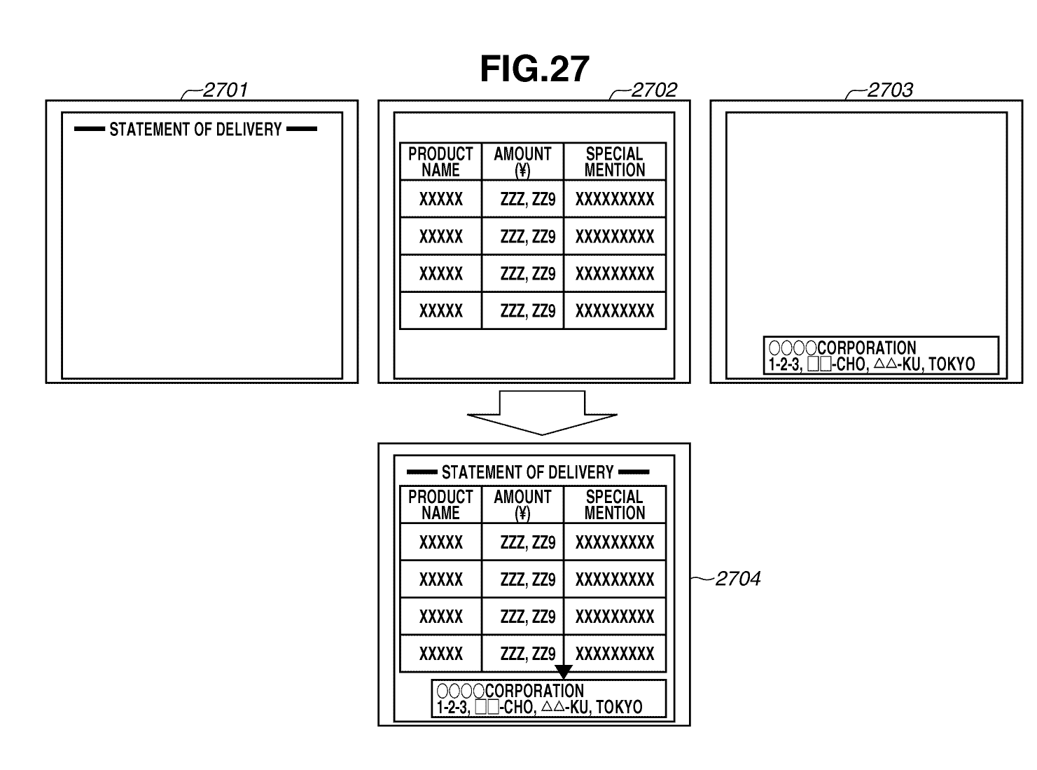

FIG. 28 illustrates an example of a composite form setting screen (GUI) that can be displayed when a user selects component forms to be used.

FIG. 29 illustrates an example of variable graphics and other graphics that are overlapped with each other, as a result of the overlay printing that partly increases the size of the variable graphics.

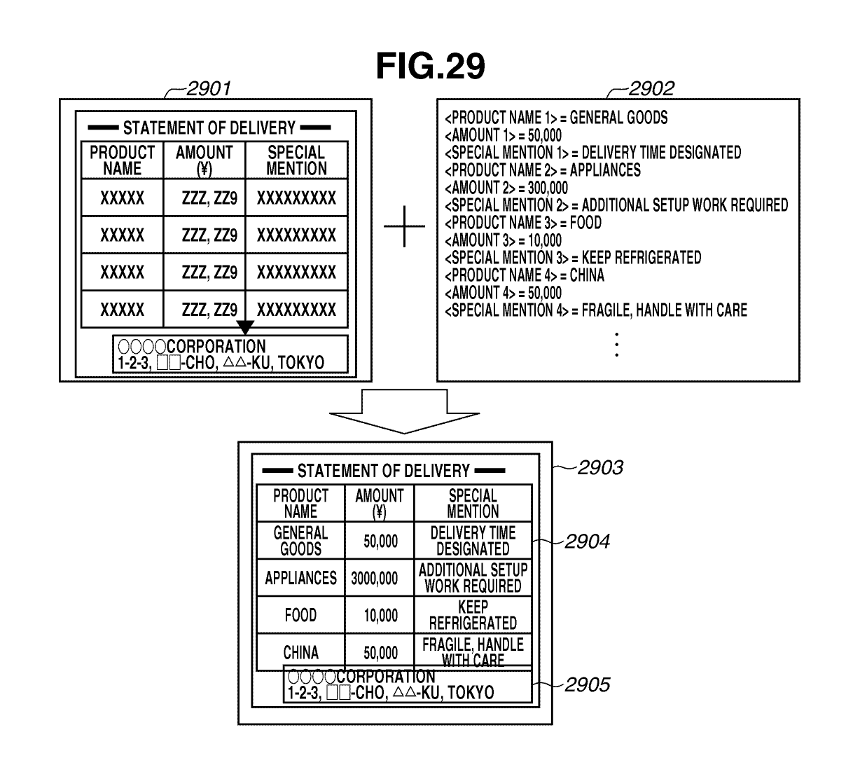

### DESCRIPTION OF THE EMBODIMENTS

Various exemplary embodiments, features, and aspects of the invention will be described in detail below with reference to the drawings.

The page printer represented by a laser printer has a “page registration” function or a “form registration” function, which can be used in the overlay printing. For example, frame lines constituting a manuscript paper format in a form can be registered beforehand as form information. When the form information is printed together with text format data (i.e., field data) by a page printer, a “page information calling” function or a “form information calling” function can be used to print a composite image by superposing (combining) the form information and the field data. The printing performed in a manner described above is generally referred to as “overlay printing.”

The form information can be generated by a dedicated form information setting system. Further, the form information is generally constituted by form graphics (i.e., stationary graphics not depending on field data) and field graphics (i.e., graphics to be used to display received field data according to an output format designated by a user).

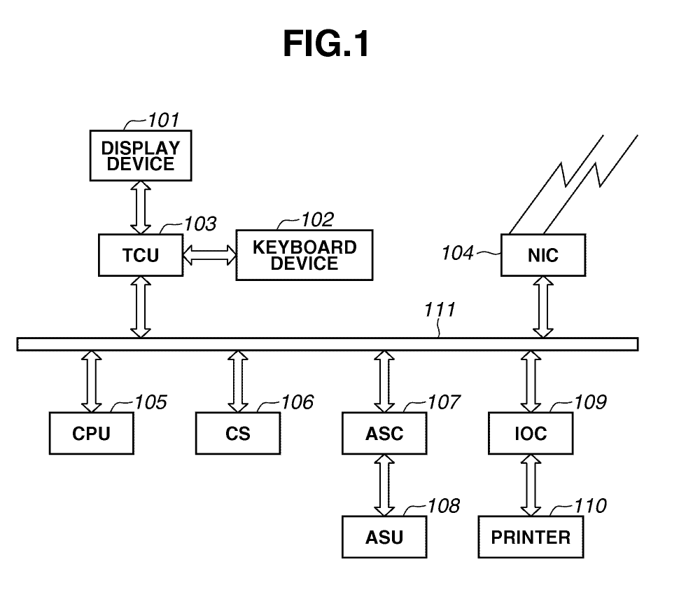

FIG. 1 illustrates an example of a configuration of a computer system, which can realize the form information setting system and an overlay printing control system according to a first exemplary embodiment of the present invention. In FIG. 1, a central processing unit (CPU) 105 is a controller installed in the computer system to control various operations to be performed by the apparatus based on control programs stored in a central storage (CS) 106 that is a main storage device. The CS 106 is a memory area that stores and executes application programs. Each application program can be loaded, via an auxiliary storage controller (ASC) 107, from an auxiliary storage unit (ASU) 108. The ASC 107 is an external storage control apparatus. The ASU 108 is an external storage apparatus. The form information setting system and the overlay printing system, which are described below, are present in the above-described memory area. The following two apparatuses can generate instructions to execute the control programs and various application programs stored in the CS 106.

The first apparatus is an operator console that includes a display device 101, a keyboard device 102, and a terminal control unit (TCU) 103 that serves as the console control apparatus. The second apparatus is a network interface controller (NIC) 104, which is a network connection facility capable of inputting instruction information to the CPU 105 of the computer system from an external computer system connected via the network. The network is, for example, a local area network (LAN) or a wide area network (WAN).

The printer 110 is connected to the computer system via an input output controller (IOC) 109. The IOC 109 is an input/output control apparatus. The printer 110 includes a memory that registers form information input, beforehand, from the computer system. The printer 110 can generate an overlay pattern by superposing field data of a text format input from the computer system with a form pattern generated based on the form information registered beforehand in the memory. The printer 110 can further perform overlay printing based on the generated overlay pattern. The TCU 103, the CPU 105, the CS 106, the ASC 107, and the IOC 109 can transmit and receive various data and program commands via a system bus 111.

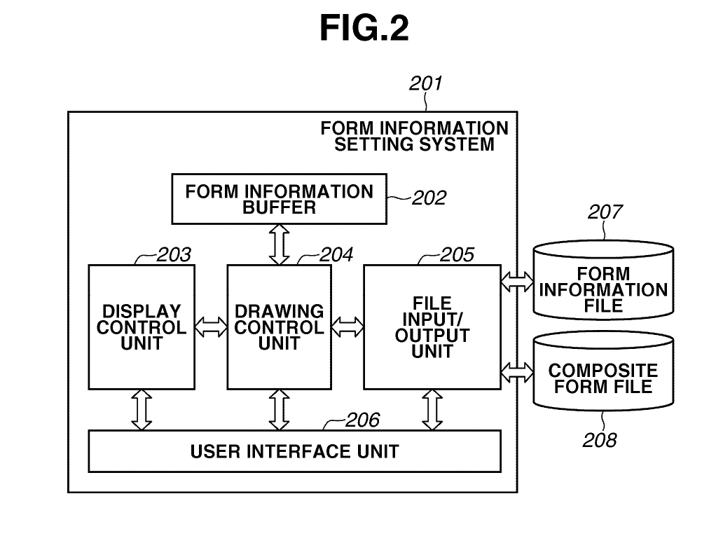

FIG. 2 is a block diagram illustrating an example of a configuration of the form information setting system. A form information setting system 201 illustrated in FIG. 2 is present in the CS 106 illustrated in FIG. 1. The CPU 105 performs the following control based on processing results of the user interface unit 206 (i.e., an overall control program) that is provided in the form information setting system 201. More specifically, the CPU 105 can control each of a form information buffer 202, a display control unit 203 (i.e., a display control program), a drawing control unit 204 (i.e., a drawing control program), and a file input/output unit 205 (i.e., a file input/output control program).

The CPU 105 receives, via the TCU 103, “execution commands and form information generation commands for the form information setting system 201” that are input via an instruction unit such as a pointing device (not illustrated), based on processing results of the display control unit 203. Then, the CPU 105 analysis the received “various commands including the execution commands and the form information generation commands for the form information setting system 201” based on the user interface unit 206 and outputs a processing request, as an internal command, to the drawing control unit 204 or to the file input/output unit 205.

Further, the CPU 105 returns processing results of the drawing control unit 204 and the file input/output unit 205 to the display control unit 203 based on a processing result of the user interface unit 206. The display device 101 displays a processing result based on a processing result of the display control unit 203. More specifically, the display control unit 203 causes the display device 101 illustrated in FIG. 1 to display a form pattern based on the form information presently set (stored) in the form information buffer 202, via the drawing control unit 204. Further, the display control unit 203 receives various commands including user setting commands and form information generation commands, which are input via the keyboard device 102 illustrated in FIG. 1 or a pointing device (not illustrated).

The drawing control unit 204 can manage the form information buffer 202. The drawing control unit 204 can input and output all elements of the generated form information in and from the form information buffer 202. The drawing control unit 204 can perform bi-directional data transmission of the data to be transferred to the display control unit 203 and to the file input/output unit 205 according to a command supplied from the user interface unit 206.

The file input/output unit 205 can write and read the form information presently set (stored) in the form information buffer 202, via the drawing control unit 204, into and from a form information file 207 based on a command supplied from the user interface unit 206. The form information file 207 is present in the ASU 108 illustrated in FIG. 1. Further, the file input/output unit 205 can perform processing for reading and writing a single form information file 207 or a composite form file 208 composed of a plurality of form information files 207, via the drawing control unit 204, based on a command supplied from the user interface unit 206.

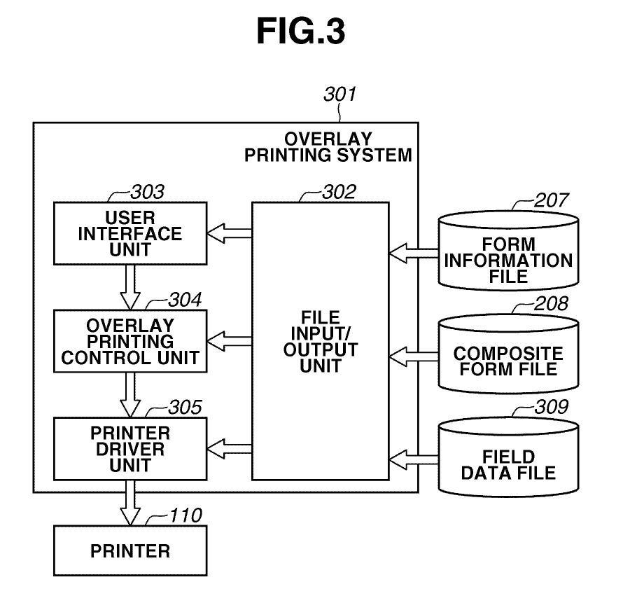

FIG. 3 is a block diagram illustrating an example of a configuration of the overlay printing system. An overlay printing system 301 illustrated in FIG. 3 is present in the CS 106 illustrated in FIG. 1. The CPU 105 performs the following control based on processing results obtained by an overlay printing control unit 304, which is provided in the overlay printing system 301. More specifically, the CPU 105 can control each of a file input/output unit 302 (i.e., a file input/output control program), a user interface unit 303 (i.e., a control program), and a printer driver unit 305 (i.e., a printer control program), which are described below in more detail.

The user interface unit 303 receives the following information, via the file input/output unit 302, from the information file 207, the composite form file 208, and a field data file 309, which are stored in the ASU 108. More specifically, the user interface unit 303 receives a list of form information file names, composite form file names, and field data file names. Then, the user interface unit 303 causes the display device 101 illustrated in FIG. 1 to display the input information. The user interface unit 303 receives “selection instruction information, such as a form information file name, a composite form file name, and a field data file name”, which is designated by a user via the keyboard device 102 or a pointing device (not illustrated). Then, the user interface unit 303 outputs the received information to the file input/output unit 302.

The file input/output unit 302 performs the following processing based on “the selection instruction information, such as a form information file name, a composite form file name, and a field data file name”, which is input via the user interface unit 303. More specifically, the file input/output unit 302 reads the form information from the form information file 207 and the composite form file 208 and reads the field data designated by the user from the field data file 309. Then, the file input/output unit 302 outputs the read form information and the field data to the overlay printing control unit 304.

The overlay printing control unit 304 receives the “form information of the form information file 207 and the composite form file 208” from the file input/output unit 302 and then outputs and registers the received data to the printer 110 via the printer driver unit 305. Further, the overlay printing control unit 304 interprets the field data of text format received via the file input/output unit 302. Then, the overlay printing control unit 304 generates intermediate data (i.e., data modified from the field data so that the printer driver unit 305 can easily generate bitmap data) and outputs the generated intermediate data to the printer driver unit 305.

Next, an example of an operation to be performed by the computer system (i.e., the form information setting system and the overlay printing control system) according to the present exemplary embodiment is described below.

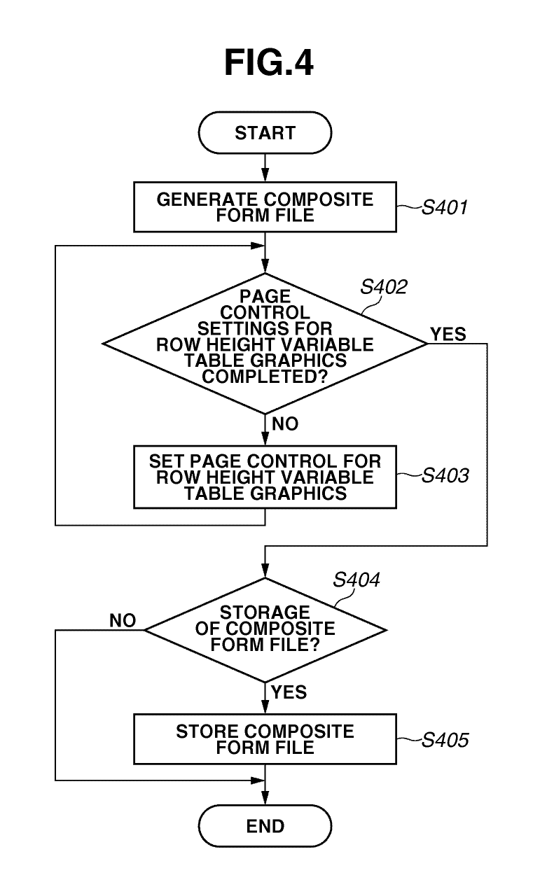

FIG. 4 is a flowchart illustrating an example of the processing to be performed by the form information setting system 201 that generates the composite form file 208 and executes page control settings for variable graphics in the composite form file 208. In the following exemplary embodiment of the present invention, the CPU 105 executes a control program corresponding to each flowchart to realize the processing of each step illustrated in the flowchart.

First, in step S401, the CPU 105 generates a composite form file 208 according to a “composite form information generation instruction entered by a user” and causes the display device 101 to display the generated composite form file 208. Next, in step S402, the CPU 105 determines whether page control settings have been completed for the variable graphics in the composite form file 208.

If it is determined that the page control settings for the variable graphics in the composite form file 208 have not been completed (NO in step S402), the CPU 105 performs the following processing. More specifically, in step S403, the CPU 105 causes the display device 101 to display a dialog that enables users to perform the page control settings for the variable graphics. If a user performs an input operation on the dialog, the CPU 105 performs page control settings for the variable graphics based on the input user's operation.

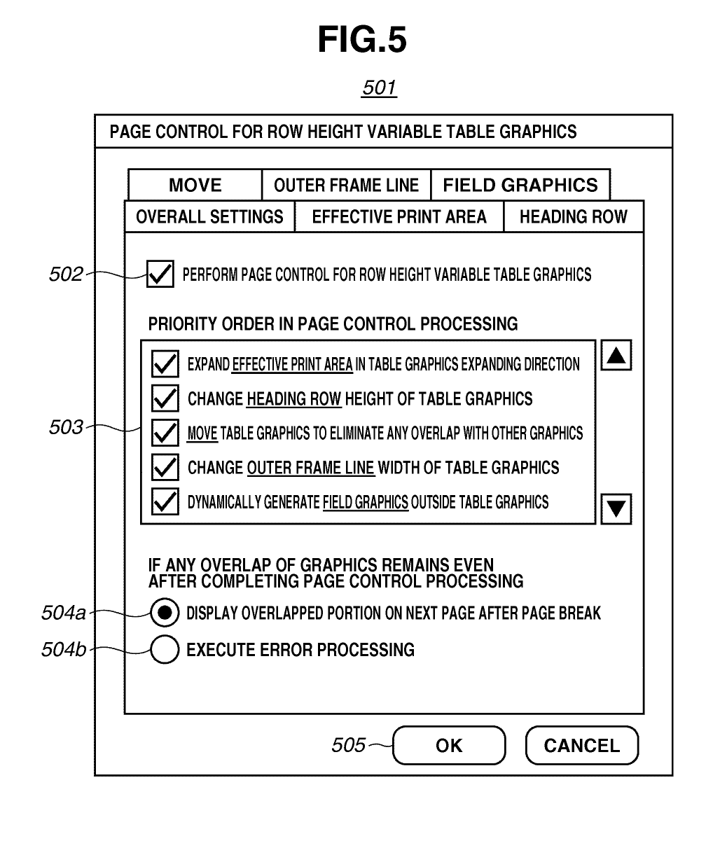

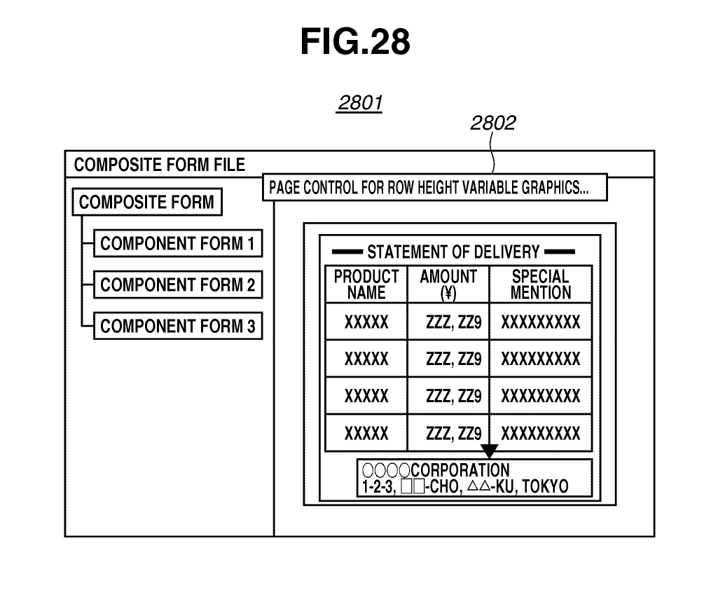

The above-described dialog can be displayed, for example, by executing a menu command 2802 that is displayed on the composite form setting screen 2801 illustrated in FIG. 28. FIG. 5 illustrates an example of the dialog that enables users to determine setting information relating to the page control settings for the variable graphics. A dialog 501 illustrated in FIG. 5 includes a check box 502 that can be checked to determine the necessity to execute the page control for variable graphics. The dialog 501 further includes a page control setting field 503 that can be checked to determine the necessity to execute each item listed as page control processing contents and a priority order of each page control processing item.

According to the page control setting field 503 illustrated in FIG. 5, the CPU 105 executes all of the page control processing items, if their check boxes are checked, according to a descending order from the top. The dialog 501 further includes radio buttons 504a and 504b that can be respectively checked to designate processing to be selected in a case where there is any overlap between the variable graphics and other graphics even after the page control processing has been executed as described below.

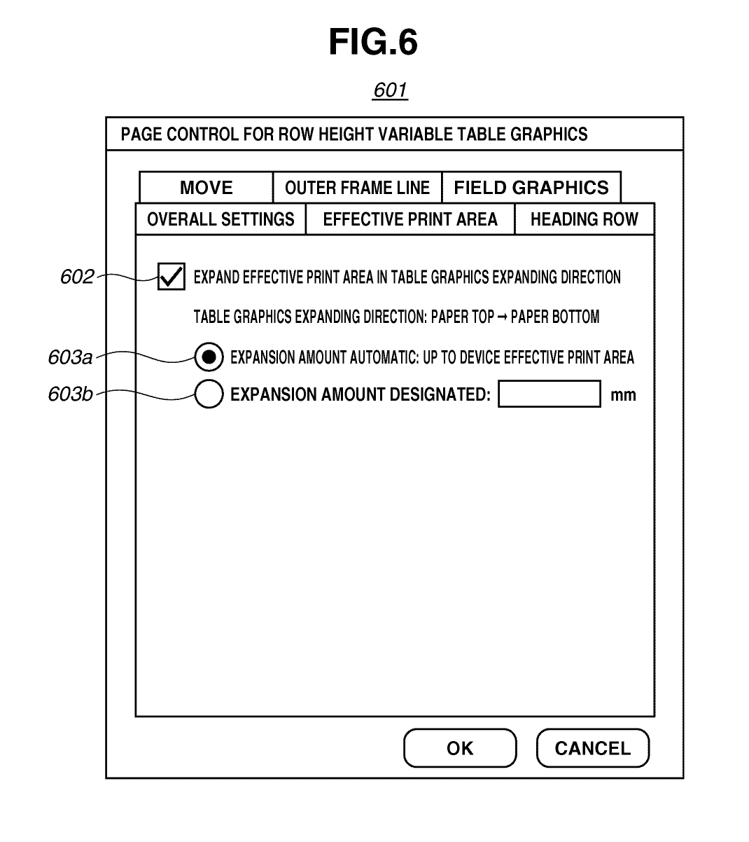

FIG. 6 illustrates an example of the dialog that enables users to set details of the page control processing to be performed to expand an effective print area of a sheet in the expansion direction of the variable graphics. A dialog 601 illustrated in FIG. 6 can be displayed in response to selection of an “effective print area” tab illustrated in the dialog 501.

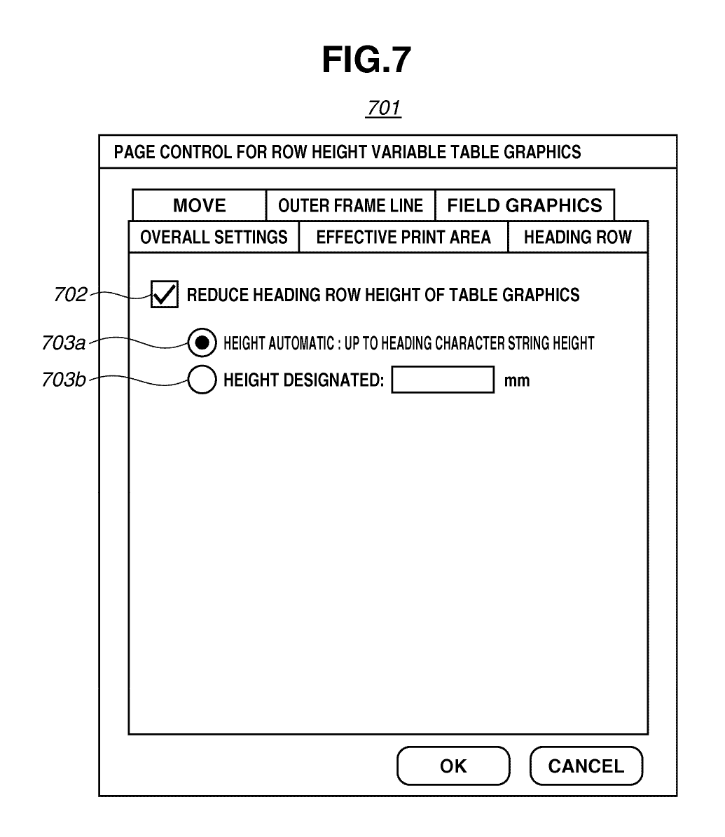

FIG. 7 illustrates an example of the dialog that enables users to set details of the page control processing to be performed to reduce the height of the heading row of the variable graphics. A dialog 701 illustrated in FIG. 7 can be displayed in response to selection of a “heading row” tab illustrated in the dialog 501.

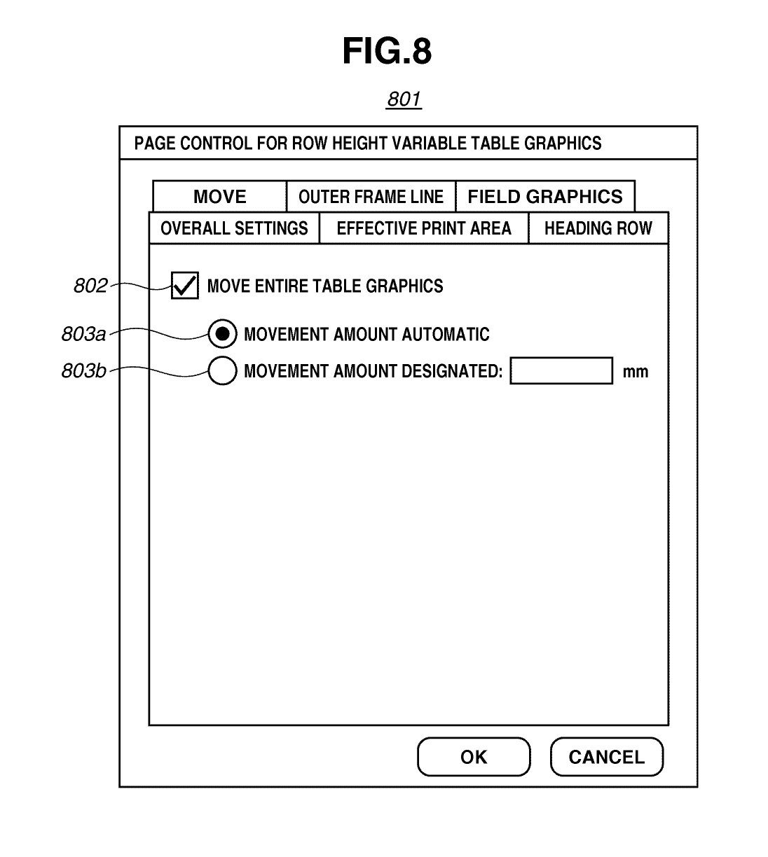

FIG. 8 illustrates an example of the dialog that enables users to set details of the page control processing to be performed to move the graphic position of the variable graphics by an amount that does not cause any overlap with other graphics. A dialog 801 illustrated in FIG. 8 can be displayed in response to selection of a “move” tab illustrated in the dialog 501.

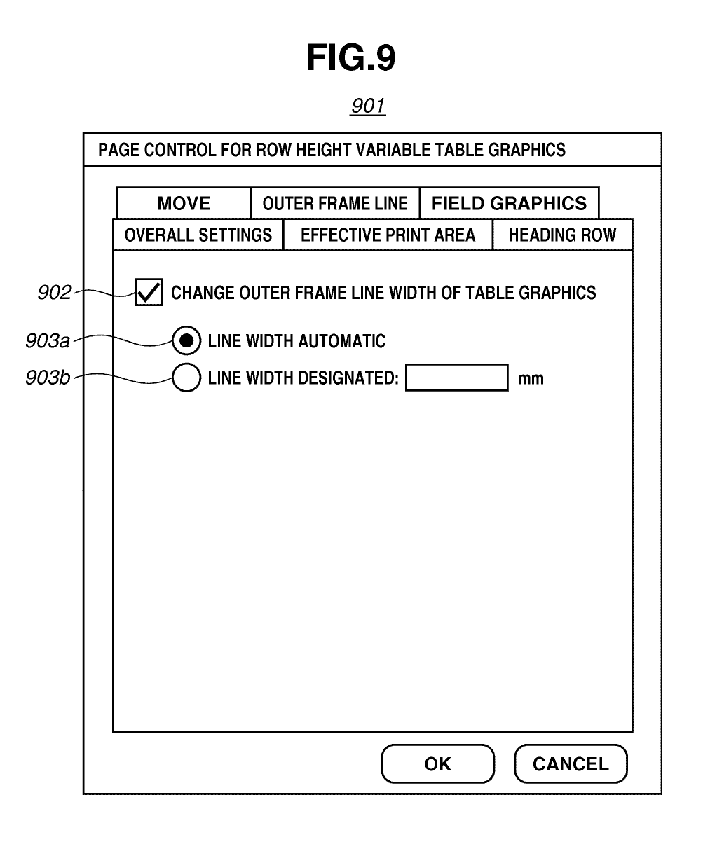

FIG. 9 illustrates an example of the dialog that enables users to set details of the page control processing to be performed to change the line width of an outer frame line of the variable graphics. A dialog 901 illustrated in FIG. 9 can be displayed in response to selection of an “outer frame line” tab illustrated in the dialog 501.

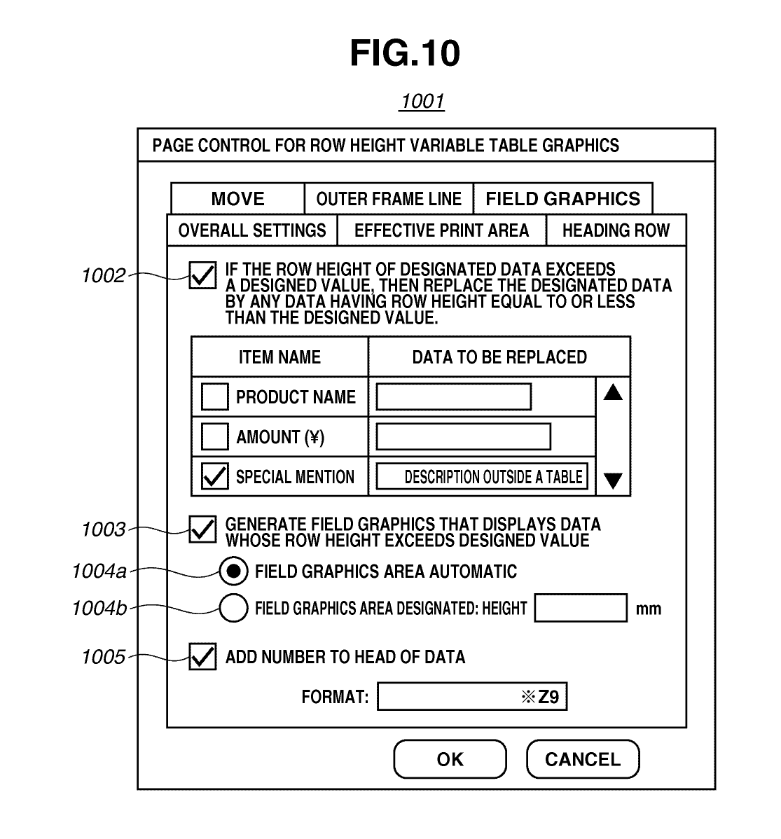

FIG. 10 illustrates an example of the dialog that enables users to set details of the following page control processing. More specifically, a dialog 1001 illustrated in FIG. 10 enables users to set details of the page control processing to be performed to replace data stored in a portion whose row height is greater than a designed row height of the variable graphics with data that can be stored in the variable graphics without changing the designed row height and further to generate field graphics for storage of original data. The dialog 1001 illustrated in FIG. 10 can be displayed in response to selection of a “field graphics” tab illustrated in the dialog 501.

Users can perform detailed settings for respective page control processing items using the above-described dialogs 601 to 1001 illustrated in FIG. 6 to FIG. 10.

Referring back to the flowchart illustrated in FIG. 4, the CPU 105 repeats the above-described processing of steps S402 and S403 until the page control settings for the variable graphics have been completed. More specifically, the CPU 105 repetitively executes the processing of steps S402 and S403 unless an OK button 505 is pressed on the dialog 501 illustrated in FIG. 5.

Then, if it is determined that the page control settings for the variable graphics have been completed (YES in step S402), then in step S404, the CPU 105 determines whether to store the composite form file 208 generated in step S401. The CPU 105 can perform the determination in step S404 based on a user's operation on the composite form setting screen 2801 illustrated in FIG. 28. Alternatively, the CPU 105 can unconditionally store the composite form file 208 generated in step S401 without executing the above-described determination processing.

If it is determined that the storage of the composite form file 208 is required (YES in step S404), then in step S405, the CPU 105 performs the processing for storing the composite form file 208. At this moment, the CPU 105 temporarily terminates the processing according to the program. On the other hand, if it is determined that the storage of the composite form file 208 is not required, the CPU 105 temporarily terminates the processing according to the program by skipping the processing of step S405.

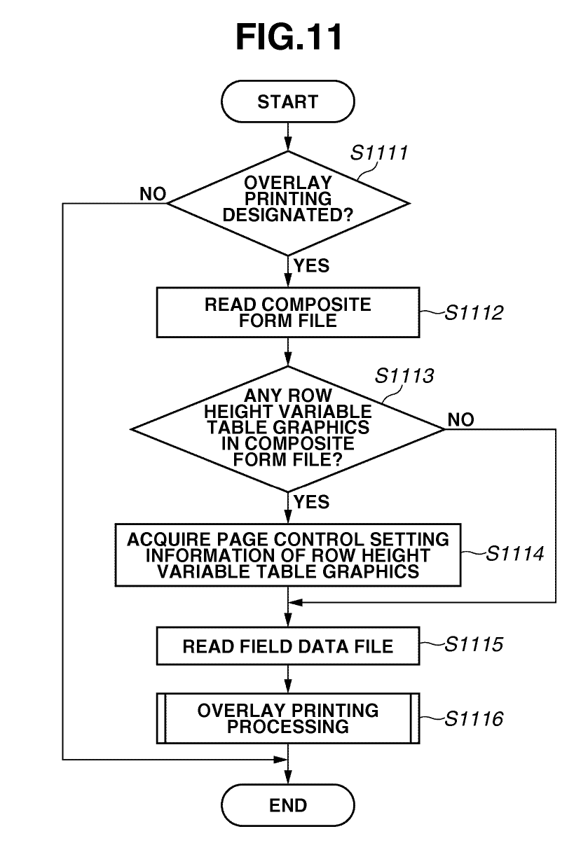

FIG. 11 is a flowchart illustrating an example of overlay print processing to be performed by the overlay printing system 301 based on the page control settings for the variable graphics stored in the composite form file 208. The control program relating to the flowchart illustrated in FIG. 11 is a software program that corresponds to the overlay printing control unit 304 illustrated in FIG. 3. When a composite form file name, a data file name, and an overlay print instruction command are input via the user interface unit 303 into the overlay printing control unit 304, the CPU 105 starts executing the control program.

First, in step S1111, the CPU 105 determines whether a user has input an “overlay print instruction.” If it is determined that there is not any overlay print instruction entered by the user (NO in step S1111), the CPU 105 terminates the processing of the flowchart illustrated in FIG. 11. On the other hand, if it is determined that there is the overlay print instruction entered by the user (YES in step S1111), then in step S1112, the CPU 105 reads a corresponding composite form file 208. Then, in step S1113, the CPU 105 determines whether the composite form file 208 includes any variable graphics. For example, to execute the processing of step S1113, the CPU 105 can check the attribute of individual graphics included in the form file.

If it is determined that the composite form file 208 does not include any variable graphics (NO in step S1113), then in step S1115, the CPU 105 reads a corresponding field data file 309. Then, in step S1116, the CPU 105 performs processing for analyzing the data read in steps S1112 and S1115 and subsequently performs the overlay print processing based on the read data.

On the other hand, if it is determined that the composite form file 208 includes the variable graphics (YES in step S1113), the CPU 105 performs the following processing. More specifically, in step S1114, the CPU 105 acquires contents of “the page control settings for the variable graphics” performed in step S403 illustrated in FIG. 4. Then, in steps S1115 and S1116, the CPU 105 reads a corresponding field data file 309 and performs the overlay print processing based on the read field data file 309.

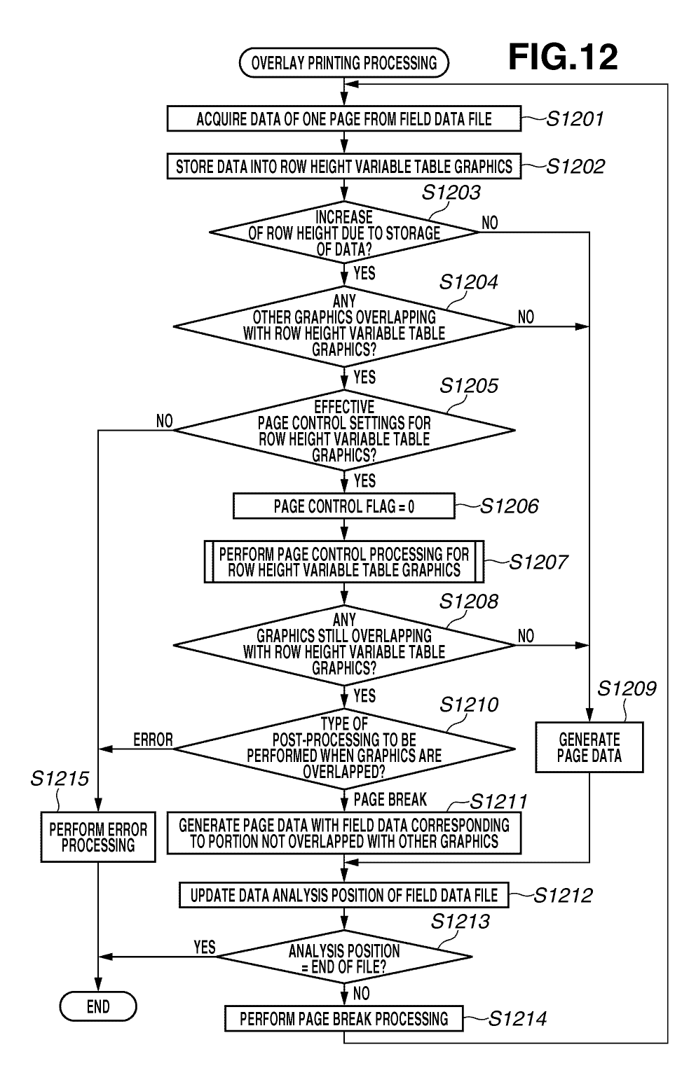

FIG. 12 is a flowchart illustrating an example of the overlay print processing to be performed in step S1116 illustrated in FIG. 11.

First, in step S1201, the CPU 105 acquires data of one page from the corresponding field data file 309. Next, in step S1202, the CPU 105 allocates the field data acquired in step S1201 to the variable graphics in the composite form file 208. In this case, if the data size of the variable graphics in the composite form file 208 is not sufficiently large to accommodate all of the data acquired in step S1201, the CPU 105 expands the size of the variable graphics according to the acquired data.

To this end, in step S1203, the CPU 105 determines whether the size of the variable graphics, if it accommodates the data allocated in step S1202, is greater than the original size of the variable graphics. For example, to realize the processing of step S1203, the CPU 105 compares the original size of the variable graphics with the changed size of the variable graphics that results from the processing performed step S1202.

If it is determined that the present size of the variable graphics is equal to the original size of the variable graphics (NO in step S1203), then in step S1209, the CPU 105 generates page data to be used for the overlay print processing.

On the other hand, if it is determined that the present size of the variable graphics is greater than the original size of the variable graphics (YES in step S1203), then in step S1204, the CPU 105 determines whether the variable graphics and other graphics are overlapped with each other. For example, the CPU 105 can execute the processing of step S1204 referring to coordinate values that define individual graphics. If it is determined that the variable graphics and other graphics are not overlapped with each other (NO in step S1204), then step S1209, the CPU 105 generates page data to be used for the overlay print processing using the size-changed variable graphics.

On the other hand, if it is determined that the variable graphics and other graphics are overlapped with each other (YES in step S1204), the CPU 105 performs the following processing. More specifically, in step S1205, the CPU 105 determines whether the page control settings for the variable graphics in the composite form file 208 are effective. For example, to realize the processing of step S1205, the CPU 105 can refer to attribute values of the variable graphics.

If it is determined that the page control settings for the variable graphics are ineffective (NO in step S1205), then in step S1215, the CPU 105 performs error processing. Subsequently, the CPU 105 terminates the processing of the flowchart illustrated in FIG. 12 (i.e., FIG. 11). The error processing to be performed in step S1215 is, for example, processing for informing a user of an inappropriate print result due to the presence of the overlapped graphics. The error processing performed by the CPU 105 enables the user to immediately know an inappropriate print result before checking an overlay printing result.

On the other hand, if it is determined that the page control settings for the variable graphics are effective (YES in step S1205), then in step S1206, the CPU 105 initializes a page control flag for the variable graphics (i.e., sets the flag to 0). Then, in step S1207, the CPU 105 performs the page control processing for the variable graphics according to the priority order having been set in the page control settings field 503 illustrated in FIG. 5. The page control processing to be performed in step S1207 is described below in more detail.

In step S1208, i.e., after completing the processing of step S1207, the CPU 105 determines whether the variable graphics and other graphics are still overlapped with each other. If it is determined that the variable graphics and other graphics are not overlapped with each other (NO in step S1208), then in step S1209, the CPU 105 generates the page data to be used for the overlay print processing referring to the result of the page control processing performed in step S1207.

On the other hand, if it is determined that the variable graphics and other graphics are still overlapped with each other (YES in step S1208), the CPU 105 performs the following processing. More specifically, in step S1210, the CPU 105 determines whether the error processing or page break processing is selected as post-processing to be executed when the overlap between two or more graphics is not eliminated even after completing the page setting processing in step S403 illustrated in FIG. 4. The page break processing is for displaying the overlapped portion on the next page. More specifically, the CPU 105 determines whether the radio button 504a or the radio button 504b is selected on the dialog 501 illustrated in FIG. 5.

If in step S1210 it is determined that the post-processing to be executed when the overlap between two or more graphics is not eliminated even after completing the page setting processing is the page break processing for displaying the overlapped portion on the next page, the CPU 105 performs the following processing. More specifically, in step S1211, the CPU 105 generates page data to be used for the overlay print processing for a processing object page using a portion of the variable graphics that is not overlapped with other graphics.

On the other hand, if in step S1210 it is determined that the post-processing to be executed when the overlap between two or more graphics is not eliminated even after completing the page setting processing is error processing, then in step S1215, the CPU 105 performs the error processing. Subsequently, the CPU 105 terminates the processing of the flowchart illustrated in FIG. 12.

In step S1212, i.e., when the page data to be used for the overlay print processing is generated after completing the processing of respective steps S1201 to S1211, the CPU 105 updates a data analysis position that is required to acquire data to be stored in the next page from the field data file 309.

Then, in step S1213, the CPU 105 determines whether the data analysis position updated in step S1212 is the end of the file. If it is determined that the data analysis position updated in step S1212 is the end of the file (YES in step S1213), the CPU 105 terminates the processing of the flowchart illustrated in FIG. 12.

On the other hand, if it is determined that the data analysis position updated in step S1212 is not the end of the file (NO in step S1213), the CPU 105 moves the processing object page to the next page (i.e., performs page break processing). Then, the processing returns to step S1201. The CPU 105 performs the processing for generating page data for the next page. As described above, in the present exemplary embodiment, the CPU 105 executes the page control processing of step S1207 on a page-by-page basis. However, the page control processing of step S1207 is not limited to the above-described processing contents. For example, in step S1207, the CPU 105 can execute the page control processing for a plurality of pages at a time.

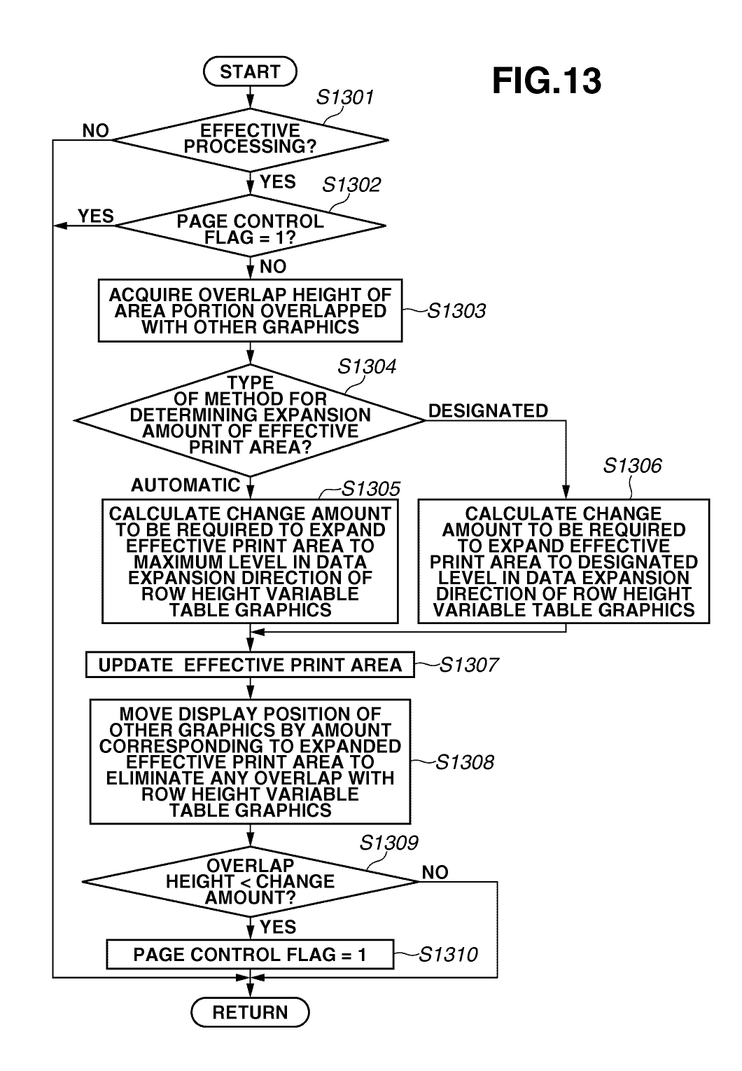

Next, an example of the page control processing to be performed in step S1207 illustrated in FIG. 12 is described below in detail. FIG. 13 is a flowchart illustrating details of example page control processing for expanding an effective print area of a sheet in the expansion direction of the variable graphics, as part of the page control processing performed in step S1207 illustrated in FIG. 12. The CPU 105 executes the above-described processing referring to the setting contents based on an operation performed on the dialog 601 illustrated in FIG. 6, as part of “the page control settings for the variable graphics” having been executed in step S403 illustrated in FIG. 4.

First, in step S1301, the CPU 105 determines whether the page control processing for expanding the effective print area of the sheet in the expansion direction of the variable graphics is effective. For example, the CPU 105 can execute the determination processing of step S1301 in response to clicking on a check box 602 on the dialog 601 illustrated in FIG. 6.

if it is determined that the page control processing for expanding the effective print area of the sheet in the expansion direction of the variable graphics is ineffective (NO in step S1301), the CPU 105 terminates the processing of the flowchart illustrated in FIG. 13. On the other hand, if it is determined that the page control processing for expanding the effective print area of the sheet in the expansion direction of the variable graphics is effective (YES in step S1301), then in step S1302, the CPU 105 determines whether the value of the page control flag is equal to “1.”

If it is determined that the value of the page control flag is equal to “1” (YES in step S1302), the CPU 105 regards the page control processing as having been completed and terminates the processing of the flowchart illustrated in FIG. 13 (i.e., the processing of the step S1207 illustrated in FIG. 12).

On the other hand, if it is determined that the value of the page control flag is not “1” (NO in step S1302), the CPU 105 performs the following processing. More specifically, in step S1303, the CPU 105 calculates an overlap height of the overlapped portion based on the area where the variable graphics and other graphics are overlapped with each other.

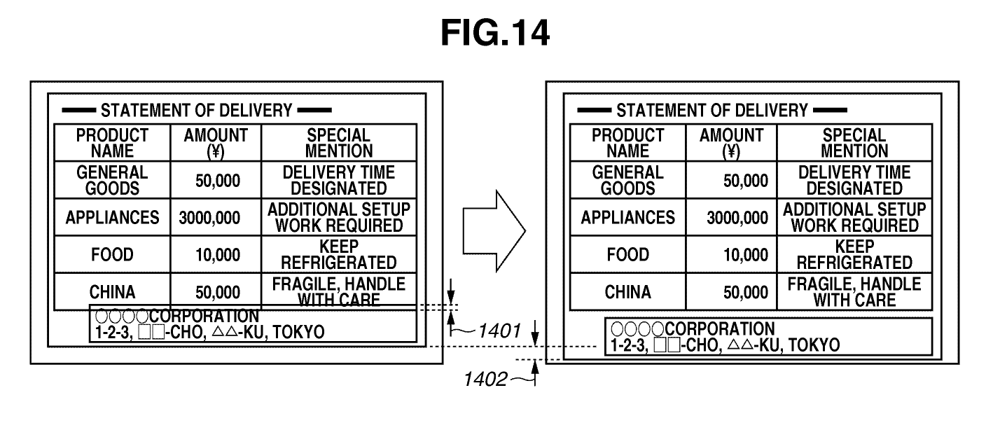

FIG. 14 illustrates a change in the layout between before and after executing the page control processing for expanding the effective print area of the sheet in the expansion direction of the variable graphics. According to the example illustrated in FIG. 14, an overlap height 1401 can be calculated in step S1303.

Next, in step S1304, the CPU 105 determines the type of a method for setting the expansion amount of the effective print area of the sheet in the expansion direction of the variable graphics. More specifically, the CPU 105 determines whether to set the expansion amount automatically or according to an amount designated by a user. The CPU 105 can execute the determination processing of step S1304 in response to selection of a radio button 603a or a radio button 603b on the dialog 601 illustrated in FIG. 6.

If in step S1304 it is determined that the expansion amount determination method is “automatic”, the CPU 105 performs the following processing. More specifically, in step S1305, after acquiring sheet effective print area information from the printer 110, the CPU 105 acquires (calculates) an expansion value that represents a change amount to be required to expand the effective print area of the sheet to a maximum level in the expansion direction of the variable graphics. According to the example illustrated in FIG. 14, the CPU 105 acquires a change amount 1402 in step S1305.

On the other hand, if in step S1304 it is determined that the expansion amount determination method is “designated” by the user, then in step S1306, the CPU 105 acquires a designated level of the effective print area of the sheet in the expansion direction of the variable graphics.

In step S1307, i.e., after completing the processing of step S1305 or step S1306, the CPU 105 updates the effective print area of the sheet based on the value acquired in step S1305 or in step S1306. Then, in step S1308, the CPU 105 moves the position of other graphics overlapped with the variable graphics in the expansion direction of the variable graphics by an amount acquired in step S1305 or in step S1306.

Next, in step S1309, the CPU 105 determines whether the overlap height 1401 acquired in step S1303 is less than the change amount 1402 acquired in step S1305 or in step S1306. Alternatively, in step S1309, the CPU 105 can determine whether the overlap height 1401 acquired in step S1303 is equal to or less than the change amount 1402 acquired in step S1305 or in step S1306. Moreover, in step S1309, the CPU 105 can determine whether the changed variable graphics and other graphics are overlapped.

If it is determined that the overlap height 1401 acquired in step S1303 is less than the change amount 1402 acquired in step S1305 or in step S1306 (YES in step S1309), the CPU 105 performs the following processing. More specifically, in step S1310, the CPU 105 updates the value of the page control flag to “1” and then terminates the processing of the flowchart illustrated in FIG. 13.

On the other hand, if it is determined that the overlap height 1401 acquired in step S1303 is equal to or greater than the change amount 1402 acquired in step S1305 or in step S1306 (NO in step S1309), the CPU 105 terminates the processing of the flowchart illustrated in FIG. 13.

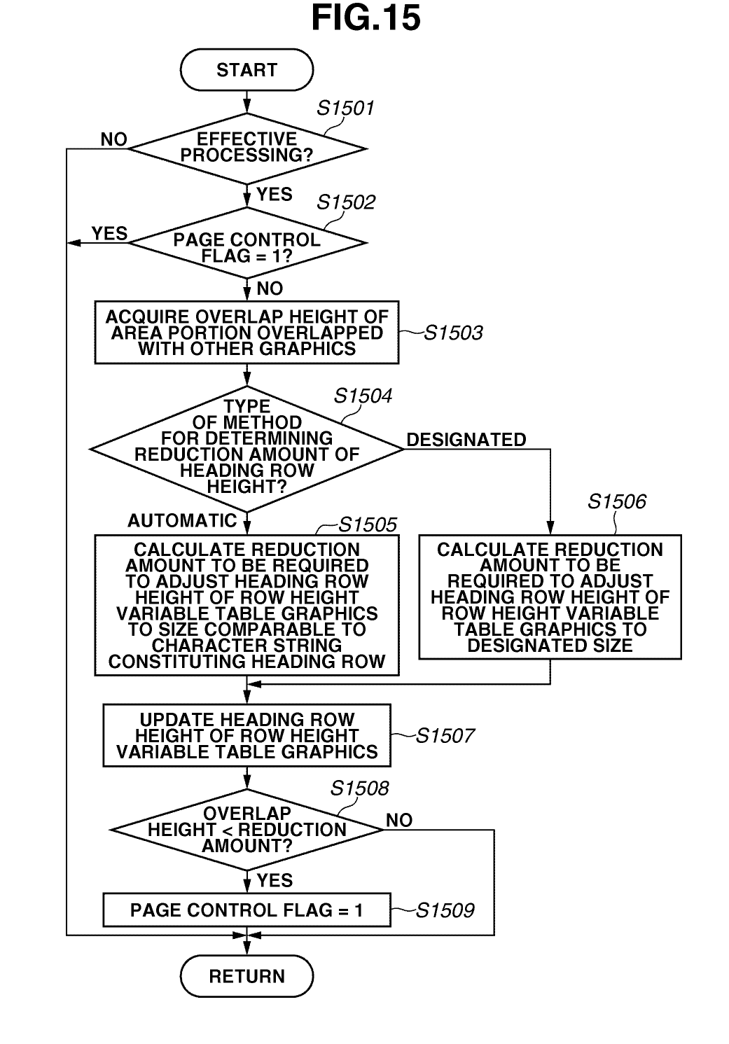

FIG. 15 is a flowchart illustrating details of example page control processing for reducing the height of the heading row of the variable graphics to a level comparable to the size of a heading character string, as part of the page control processing performed in step S1207 illustrated in FIG. 12. The CPU 105 executes the above-described processing referring to the setting contents based on an operation performed on the dialog 701 illustrated in FIG. 7, as part of “the page control settings for the variable graphics” having been executed in step S403 illustrated in FIG. 4.

First, in step S1501, the CPU 105 determines whether the page control processing for reducing the height of the heading row of the variable graphics to the level comparable to the size of the heading character string is effective. For example, the CPU 105 can execute the determination processing of step S1501 in response to clicking on a check box 702 on the dialog 701 illustrated in FIG. 6.

If it is determined that the page control processing for reducing the height of the heading row of the variable graphics to the level comparable to the size of the heading character string is ineffective (NO in step S1501), the CPU 105 terminates the processing of the flowchart illustrated in FIG. 15. On the other hand, if it is determined that the page control processing for reducing the height of the heading row of the variable graphics to the level comparable to the size of the heading character string is effective (YES in step S1501), then in step S1502, the CPU 105 determines whether the value of the page control flag is equal to “1.”

If it is determined that the value of the page control flag is equal to “1” (YES in step S1502), the CPU 105 regards the page control processing as having been completed and terminates the processing of the flowchart illustrated in FIG. 15. Namely, the CPU 105 terminates the processing of step S1207 illustrated in FIG. 12.

On the other hand, if it is determined that the value of the page control flag is not equal to “1” (NO in step S1502), the CPU 105 performs the following processing. More specifically, in step S1503, the CPU 105 calculates an overlap height of the overlapped portion based on the area where the variable graphics and other graphics are overlapped with each other.

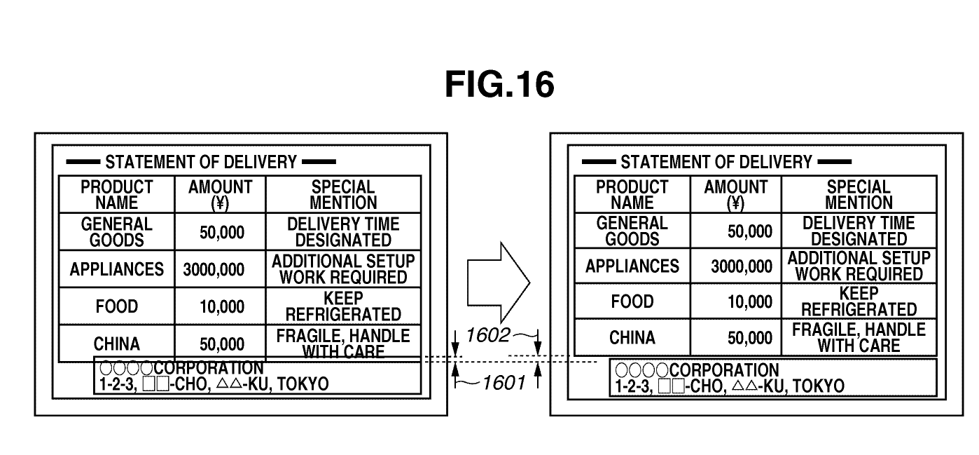

FIG. 16 illustrates a change in the layout between before and after the page control processing for reducing the height of the heading row of the variable graphics to the level comparable to the size of the heading character string. According to the example illustrated in FIG. 16, an overlap height 1601 can be calculated in step S1503.

Next, in step S1504, the CPU 105 determines the type of a method for setting the reduction amount of the height of the heading row of the variable graphics. More specifically, the CPU 105 determines whether to set the reduction amount automatically or according to an amount designated by a user. The CPU 105 can execute the determination processing of step S1504 in response to selection of a radio button 703a or a radio button 703b on the dialog 701 illustrated in FIG. 7.

If in step S1504 it is determined that the reduction amount determination method is “automatic”, the CPU 105 performs the following processing. More specifically, in step S1505, the CPU 105 calculates a reduction amount to be required to reduce the height of the heading row of the variable graphics to the level comparable to the size of the heading character string. According to the example illustrated in FIG. 16, a reduction amount 1602 is calculated.

On the other hand, if in step S1504 it is determined that the reduction amount determination method is “designated” by the user, in step S1506, the CPU 105 acquires, as a reduction amount, a designation value of the height of the heading row of the variable graphics.

In step S1507, i.e., after completing the processing of step S1505 or step S1506, the CPU 105 updates the height of the heading row of the variable graphics based on the value calculated in step S1505 or in step S1506.

Next, in step S1508, the CPU 105 determines whether the overlap height 1601 calculated in step S1503 is less than the reduction amount 1602 calculated in step S1505 or in step S1506. Alternatively, in step S1508, the CPU 105 can determine whether the overlap height 1601 acquired in step S1503 is equal to or less than the reduction amount 1602 acquired in step S1505 or in step S1506. Moreover, in step S1508, the CPU 105 can determine whether the changed variable graphics and other graphics are overlapped with each other.

If it is determined that the overlap height 1601 calculated in step S1503 is less than the reduction amount 1602 calculated in step S1505 or in step S1506 (YES in step S1508), the CPU 105 performs the following processing. More specifically, in step S1509, the CPU 105 updates the value of the page control flag to “1” and then terminates the processing of the flowchart illustrated in FIG. 15.

On the other hand, if it is determined that the overlap height 1601 calculated in step S1503 is equal to or greater than the reduction amount 1602 calculated in step S1505 or in step S1506 (NO in step S1508), the CPU 105 terminates the processing of the flowchart illustrated in FIG. 15.

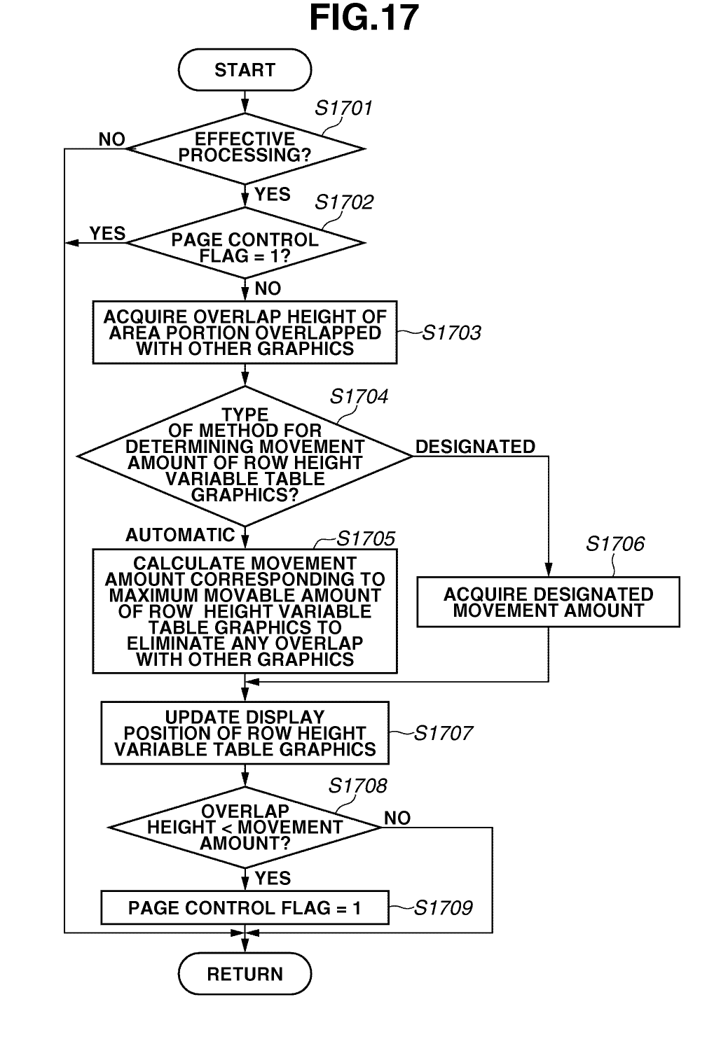

FIG. 17 is a flowchart illustrating details of example page control processing for moving the graphic position of the variable graphics by an amount that does not cause any overlap with other graphics, as part of the page control processing performed in step S1207 illustrated in FIG. 12. The CPU 105 executes the above-described processing referring to the setting contents based on an operation performed on the dialog 801 illustrated in FIG. 8, as part of “the page control settings for the variable graphics” having been executed in step S403 illustrated in FIG. 4.

First, in step S1701, the CPU 105 determines whether the page control processing for moving the graphic position of the variable graphics by the amount that does not cause any overlap with other graphics is effective. For example, the CPU 105 can execute the determination processing of step S1701 in response to clicking on a check box 802 on the dialog 801 illustrated in FIG. 8.

If it is determined that the page control processing for moving the graphic position of the variable graphics by the amount that does not cause any overlap with other graphics is ineffective (NO in step S1701), the CPU 105 terminates the processing of the flowchart illustrated in FIG. 17.

On the other hand, if it is determined that the page control processing for moving the graphic position of the variable graphics by the amount that does not cause any overlap with other graphics is effective (YES in step S1701), then in step S1702, the CPU 105 determines whether the value of the page control flag is equal to “1.”

If it is determined that the value of the page control flag is equal to “1” (YES in step S1702), the CPU 105 regards the page control processing as having been completed and terminates the processing of the flowchart illustrated in FIG. 17. Namely, the CPU 105 terminates the processing of step S1207 illustrated in FIG. 12.

On the other hand, if it is determined that the value of the page control flag is not equal to “1” (NO in step S1702), the CPU 105 performs the following processing. More specifically, in step S1703, the CPU 105 calculates an overlap height of the overlapped portion based on the area where the variable graphics and other graphics are overlapped with each other.

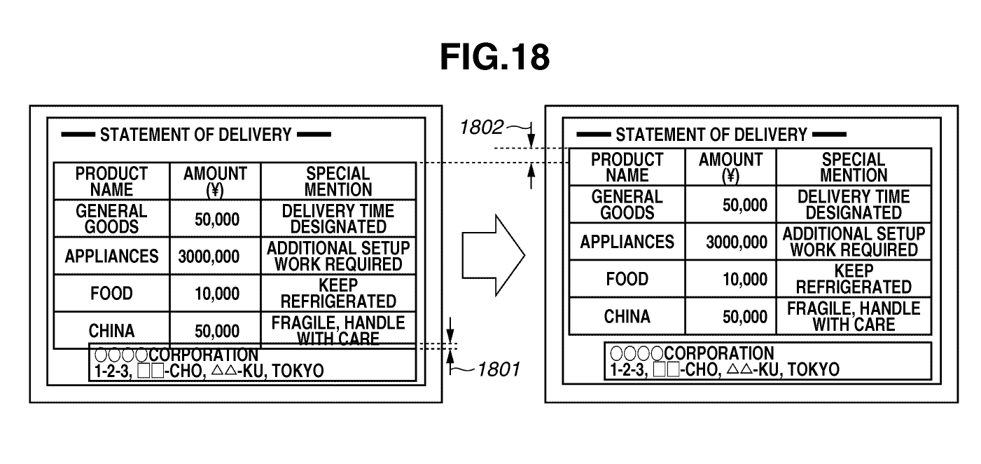

FIG. 18 illustrates a change in the layout between before and after the page control processing for moving the graphic position of the variable graphics by an amount that does not cause any overlap with other graphics. According to the example illustrated in FIG. 18, an overlap height 1801 can be calculated in step S1703. Next, in step S1704, the CPU 105 determines the type of a method for setting a movement amount of the variable graphics. More specifically, the CPU 105 determines whether to set the movement amount automatically or according to an amount designated by a user. The CPU 105 can execute the determination processing of step S1704 in response to selection of a radio button 803a or a radio button 803b on the dialog 801 illustrated in FIG. 8.

If in step S1704 it is determined that the movement amount determination method is “automatic”, the CPU 105 performs the following processing. More specifically, in step S1705, the CPU 105 calculates a movement amount that corresponds to a maximum movable amount of the variable graphics to eliminate any overlap between the variable graphics and other graphics. According to the example illustrated in FIG. 18, a movement amount 1802 can be calculated in step S1705.

On the other hand, if in step S1704 it is determined that the movement amount acquisition method is “designated” by the user, then in step S1706, the CPU 105 acquires a designation value of the movement amount.

After completing the processing of step S1705 or step S1706, in step S1707 the CPU 105 updates a display position of the variable graphics based on the value acquired in step S1705 or in step S1706.

Next, in step S1708, the CPU 105 determines whether the overlap height 1801 acquired in step S1703 is less than the movement amount 1802 acquired in step S1705 or step S1706. Alternatively, in step S1708, the CPU 105 can determine whether the overlap height 1801 acquired in step S1703 is equal to or less than the movement amount 1802 acquired in step S1705 or step S1706. Moreover, in step S1708, the CPU 105 can determine whether the changed variable graphics and other graphics are overlapped with each other.

If it is determined that the overlap height 1801 acquired in step S1703 is less than the movement amount 1802 acquired in step S1705 or step S1706 (YES in step S1708), the CPU 105 performs the following processing. More specifically, in step S1709, the CPU 105 updates the value of the page control flag to “1” and then terminates the processing of the flowchart illustrated in FIG. 17.

On the other hand, if it is determined that the overlap height 1801 acquired in step S1703 is equal to or greater than the movement amount 1802 acquired in step S1705 or in step S1706 (NO in step S1708), the CPU 105 terminates the processing of the flowchart illustrated in FIG. 17.

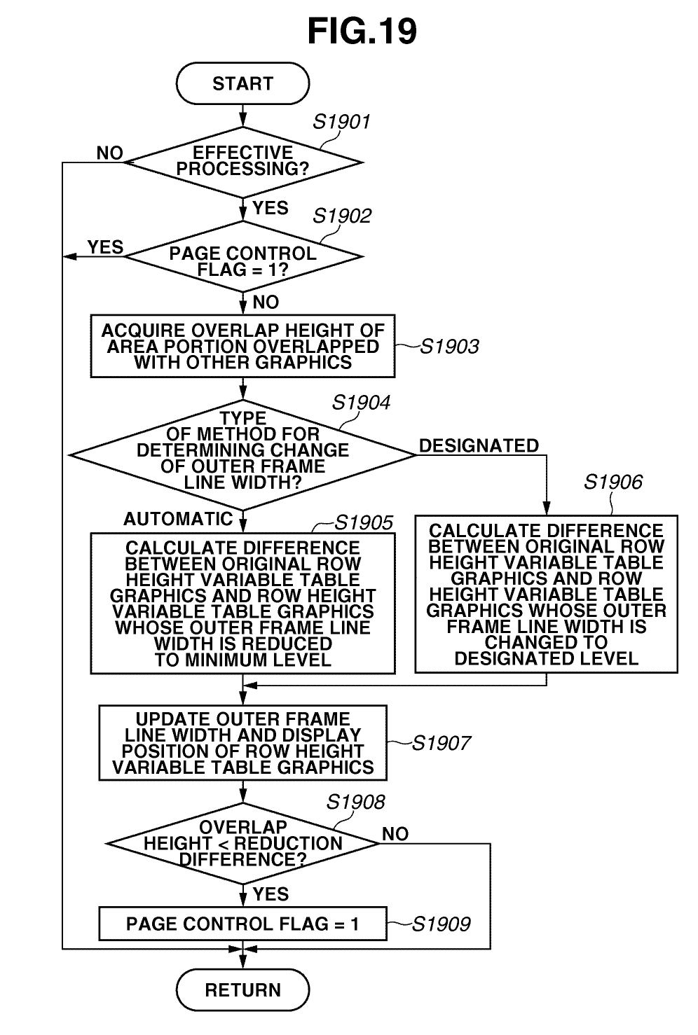

FIG. 19 is a flowchart illustrating details of example page control processing for changing the line width of an outer frame line of the variable graphics, as part of the page control processing performed in step S1207 illustrated in FIG. 12. The CPU 105 executes the above-described processing referring to the setting contents based on an operation performed on the dialog 901 illustrated in FIG. 9, as part of “the page control settings for the variable graphics” having been executed in step S403 illustrated in FIG. 4.

First, in step S1901, the CPU 105 determines whether the page control processing for changing the line width of the outer frame line of the variable graphics to a minimum value is effective. For example, the CPU 105 can execute the determination processing of step S1901 in response to clicking on a check box 902 on the dialog 901 illustrated in FIG. 9.

If it is determined that the page control processing for changing the line width of the outer frame line of the variable graphics to the minimum value is ineffective (NO in step S1901), the CPU 105 terminates the processing of the flowchart illustrated in FIG. 19.

On the other hand, if it is determined that the page control processing for changing the line width of the outer frame line of the variable graphics to the minimum value is effective (YES in step S1901), then in step S1902, the CPU 105 determines whether the value of the page control flag is equal to “1.”

If it is determined that the value of the page control flag is equal to “1” (YES in step S1902), the CPU 105 regards the page control processing as having been completed and terminates the processing of the flowchart illustrated in FIG. 19. Namely, the CPU 105 terminates the processing of step S1207 illustrated in FIG. 12.

On the other hand, if it is determined that the value of the page control flag is “1” (NO in step S1902), the CPU 105 performs the following processing. More specifically, in step S1903, the CPU 105 calculates an overlap height of the overlapped portion based on the area where the variable graphics and other graphics are overlapped with each other.

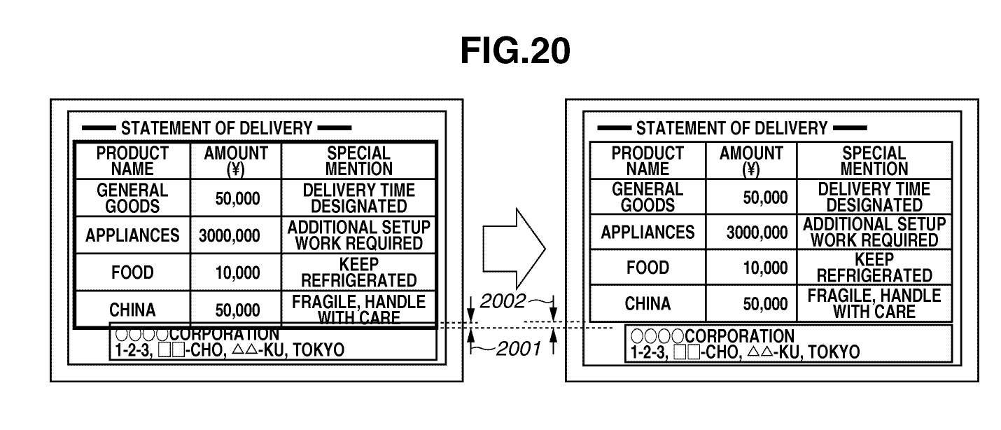

FIG. 20 illustrates a change in the layout between before and after the page control processing for changing the line width of the outer frame line of the variable graphics to the minimum value. According to the example illustrated in FIG. 20, an overlap height 2001 can be calculated in step S1903.

Next, in step S1904, the CPU 105 determines the type of a method for changing the line width of the outer frame line of the variable graphics. More specifically, the CPU 105 determines whether to set the line width of the outer frame line automatically or according to an amount designated by a user. The CPU 105 can execute the determination processing in step S1904 in response to selection of a radio button 903a or a radio button 903b on the dialog 901 illustrated in FIG. 9.

If in step S1904 it is determined that the method for changing the line width of the outer frame line is “automatic”, the CPU 105 performs the following processing. More specifically, in step S1905, the CPU 105 calculates a difference between the original size of the variable graphics and the size of a modified variable graphics obtained by changing the line width of the outer frame line to the minimum level. According to the example illustrated in FIG. 20, a difference 2002 can be calculated. Alternatively, the CPU 105 can calculate a difference between a doubled width of the original outer frame line and a doubled width of a changed outer frame line.

On the other hand, if in step S1904 it is determined that the method for changing the line width of the outer frame line is “designated” by the user, the CPU 105 performs the following processing. More specifically, in step S1906, the CPU 105 calculates a difference between the original size of the variable graphics and the size of a modified variable graphics obtained by changing the line width of the outer frame line to a designated value.

In step S1907, i.e., after completing the processing of step S1905 or step S1906, the CPU 105 updates the line width of the outer frame line of the variable graphics and the position of the variable graphics based on the value acquired in step S1905 or in step S1906.

Next, in step S1908, the CPU 105 determines whether the overlap height 2001 acquired in step S1903 is less than the difference 2002 acquired in step S1905 or in step S1906. Alternatively, in step S1908, the CPU 105 can determine whether the overlap height 2001 acquired in step S1903 is equal to or less than the difference 2002 acquired in step S1905 or in step S1906. Moreover, in step S1908, the CPU 105 can determine whether the changed variable graphics and other graphics are overlapped with each other.

If it is determined that the overlap height 2001 acquired in step S1903 is less than the difference 2002 acquired in step S1905 or in step S1906 (YES in step S1908), the CPU 105 performs the following processing. More specifically, in step S1909, the CPU 105 updates the value of the page control flag to “1” and terminates the processing of the flowchart illustrated in FIG. 17.

On the other hand, if it is determined that the overlap height 2001 acquired in step S1903 is equal to or greater than the difference 2002 acquired in step S1905 or in step S1906 (NO in step S1908), the CPU 105 terminates the processing of the flowchart illustrated in FIG. 19.

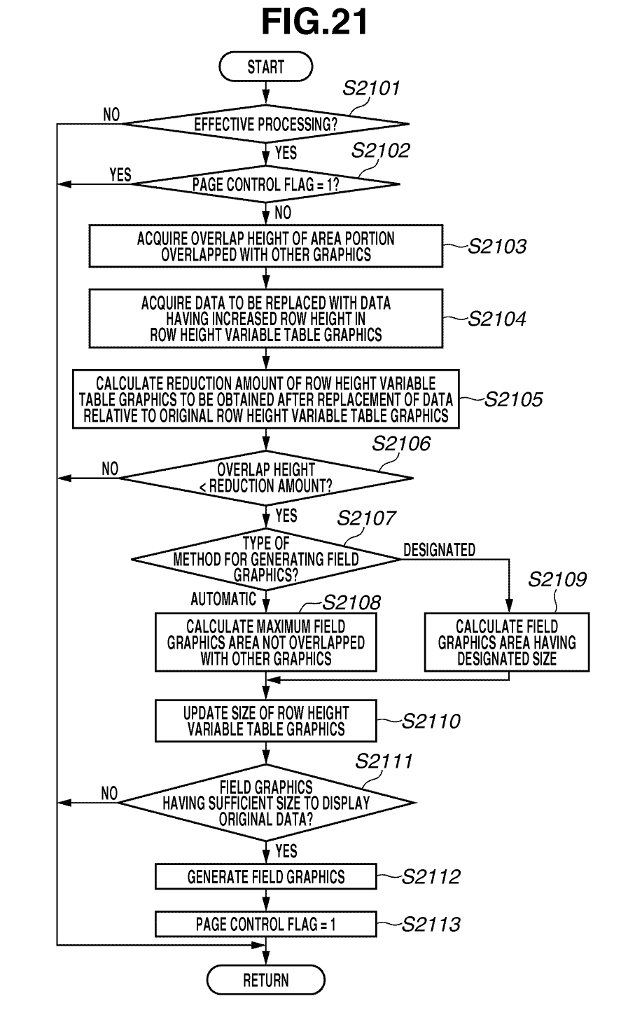

FIG. 21 is a flowchart illustrating details of example page control processing for replacing data in an enlarged portion where the row height becomes larger than the original row height with other data having a smaller data size that can be accommodated in the original row height and generating field graphics for storing the original data, as part of the page control processing performed in step S1207 illustrated in FIG. 12. The CPU 105 executes the above-described processing referring to the setting contents based on an operation performed on the dialog 1001 illustrated in FIG. 10, as part of “the page control settings for the variable graphics” having been executed in step S403 illustrated in FIG. 4.

First, in step S2101, the CPU 105 determines whether the page control processing for replacing the data in the enlarged portion where the row height becomes larger than the original row height with other data having a smaller data size that can be accommodated in the original row height and generating field graphics for storing the original data is effective. For example, the CPU 105 can execute the determination processing of step S2101 in response to clicking on a check box 1002 on the dialog 1001 illustrated in FIG. 10.

If it is determined that the page control processing for replacing the data in the enlarged portion where the row height becomes larger than the original row height with other data having a smaller data size that can be accommodated in the original row height and generating field graphics for storing the original data is ineffective (NO in step S2101), the CPU 105 terminates the processing illustrated in FIG. 21.

On the other hand, if it is determined that the page control processing for replacing the data in the enlarged portion where the row height becomes larger than the original row height with other data having a smaller data size that can be accommodated in the original row height and generating field graphics for storing the original data is effective (YES in step S2101), the CPU 105 performs the following processing. More specifically, in step S2102, the CPU 105 determines whether the value of the page control flag is equal to “1.”

If it is determined that the value of the page control flag is equal to “1” (YES in step S2102), the CPU 105 regards the page control processing as having been completed and terminates the processing of the flowchart illustrated in FIG. 21. Namely, the CPU 105 terminates the processing of step S1207 illustrated in FIG. 12.

On the other hand, if it is determined that the value of the page control flag is not “1” (NO in step S2102), the CPU 105 performs the following processing. More specifically, in step S2103, the CPU 105 calculates an overlap height of the overlapped portion based on the area where the variable graphics and other graphics are overlapped with each other.

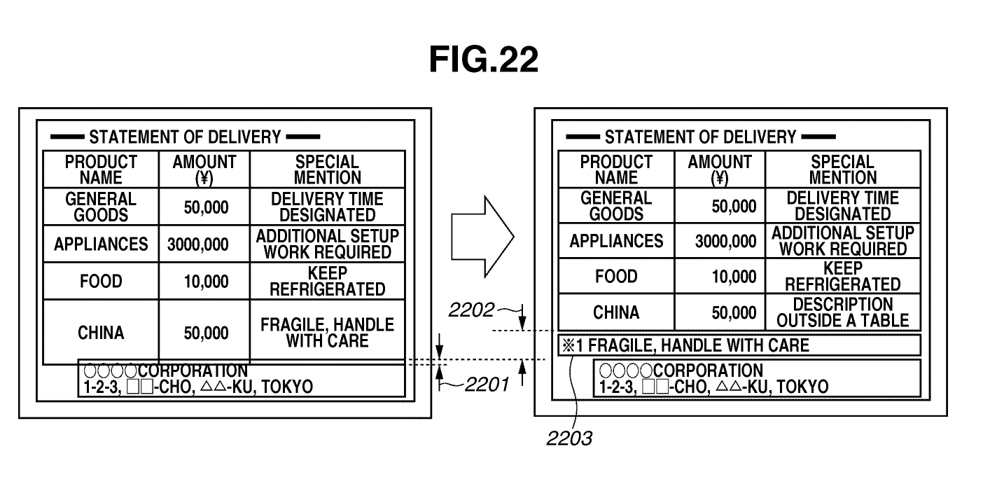

FIG. 22 illustrates a change in the layout between before and after the page control processing for replacing the data in the enlarged portion where the row height becomes larger than the original row height with other data having a smaller data size that can be accommodated in the original row height and generating field graphics for storing the original data. According to the example illustrated in FIG. 22, an overlap height 2201 can be calculated in step S2103.

Next, in step S2104, the CPU 105 acquires data to be replaced with the data in the enlarged portion where the row height becomes larger than the original row height. The above-described data can be set beforehand on the dialog 1001 illustrated in FIG. 10. According to the examples illustrated in FIGS. 10 and 22, example data “description outside a table” can be acquired in step S2104.

Next, in step S2105, the CPU 105 calculates a reduction amount of the variable graphics to be obtained after data replacement using the data acquired in step S2104 relative to the original variable graphics. According to the example illustrated in FIG. 22, a reduction amount 2202 can be calculated in step S2105.

Next, in step S2106, the CPU 105 determines whether the overlap height 2201 acquired in step S2103 is less than the reduction amount 2202 acquired in step S2105. Alternatively, in step S2106, the CPU 105 can determine whether the overlap height 2201 acquired in step S2103 is equal to or less than the reduction amount 2202 acquired in step S2105.

If it is determined that the overlap height 2201 acquired in step S2103 is not less than the reduction amount 2202 acquired in step S2105 (NO in step S2106), the CPU 105 terminates the processing of the flowchart illustrated in FIG. 21.

On the other hand, if it is determined that the overlap height 2201 acquired in step S2103 is less than the reduction amount 2202 acquired in step S2105 (YES in step S2106), the CPU 105 performs the following processing. More specifically, in step S2107, the CPU 105 determines the type of a method for generating a field graphics area 2203 for storing the original data prior to the replacement. The CPU 105 can execute the determination processing of step S2107 in response to clicking on a check box 1003 and selection of a radio button 1004a or a radio button 1004b on the dialog 1001 illustrated in FIG. 10.

If in step S2107 it is determined that the field graphics area generation method is “automatic”, then in step S2108, the CPU 105 calculates the field graphics area 2203 having a maximum size that does not cause any overlap with other graphics.

On the other hand, if in step S2107 it is determined that the field graphics area generation method is “designated” by the user, then in step S2109, the CPU 105 calculates the field graphics area 2203 having a designated size.

In step S2110, after completing the processing of step S2108 or step S2109, the CPU 105 updates the size of the variable graphics based on the size acquired in step S2108 or in step S2109. Next, in step S2111, the CPU 105 determines whether the size of the field graphics generated based on the size acquired in step S2108 or in step S2109 is sufficiently large to store all of the original data. For example, the CPU 105 can execute the determination processing of step S2111 by checking whether the character attribute used to store all of the original data in the field graphics area 2203 is within an effective range determined by the form information setting system 201.

If it is determined that the size of the generated field graphics is not sufficiently large to store all of the original data (NO in step S2111), the CPU 105 terminates the processing of the flowchart illustrated in FIG. 21.

On the other hand, if it is determined that the size of the generated field graphics is sufficiently large to store all of the original data (YES in step S2111), the CPU 105 performs the following processing. More specifically, in step S2112, the CPU 105 generates the field graphics. Then, in step S2113, the CPU 105 updates the value of the page control flag to “1.” Then, the CPU 105 terminates the processing of the flowchart illustrated in FIG. 21.

Further, an additional step can be inserted between step S2112 and step S2113 to determine whether the variable graphics and other graphics are overlapped with each other. In this case, if it is determined that the variable graphics and other graphics are overlapped with each other, the processing proceeds to step S2113. If it is determined that the variable graphics and other graphics are not overlapped with each other, the CPU 105 terminates the processing of the flowchart illustrated in FIG. 21.

In the present exemplary embodiment, the dialog 1001 illustrated in FIG. 10 includes a check box 1005 that can be checked if a display of an identification number added to the head of the data is required to indicate the relationship between the original data and the data to be replaced. This is useful because the user can easily know the relationship between the original data and the data to be replaced even in a case where one variable graphics include a plurality of data to be replaced.

As described above, in the present exemplary embodiment, the CPU 105 performs the following processing in a case where the area size of the row height variable graphics (i.e., an example of the field data) becomes greater than the original size and when the variable graphics and other graphics are overlapped with each other. More specifically, the CPU 105 changes at least one of the size of the variable graphics, the position of the variable graphics, and the size of a print area to eliminate any overlap between the variable graphics and other graphics.

In this case, for example, the CPU 105 reduces the size of the variable graphics by reducing the thickness of an outer frame line of the variable graphics, by reducing the heading row of the variable graphics. Alternatively, the CPU 105 reduces the size of the variable graphics by replacing the data in the enlarged portion where the row height becomes larger than the original row height with smaller data and displaying the original data in another area. Accordingly, the present exemplary embodiment can realize the overlay printing capable of eliminating any overlap between the variable graphics and other graphics without requiring resetting of component forms that constitute a composite form and further without depending on the data to be combined with the component form.

Accordingly, even when the layout area of field data in a form is variable depending on the volume (contents) of the field data, the present exemplary embodiment can easily and surely prevent an image to be formed based on the field data from being overlapped with other image. Further, the present exemplary embodiment can reduce the amount of sheets to be used for the printing because the overlay print processing can be efficiently executed. Moreover, the present exemplary embodiment can reduce the costs for the maintenance and management of forms and the costs for the overlay printing. As a result, the present exemplary embodiment can reduce total cost of ownership (TCO).

As described above, according to the present exemplary embodiment, in step S1207, the CPU 105 successively executes the page control processing for all of the items checked in the page control settings field 503 with reference to the priority order illustrated in FIG. 5.

However, the CPU 105 can terminate the processing of step S1207 if it is determined the overlap of graphics has been thoroughly eliminated before completing the processing of all of the checked page control items. More specifically, the CPU 105 executes the processing of each page control item according to the priority order and determines whether the overlap of graphics has been thoroughly eliminated every time when the processing of each page control item is accomplished. If it is determined that the overlap of graphics has been thoroughly eliminated, the processing proceeds to step S1208.

Next, a second exemplary embodiment of the present invention is described below. According to the above-described first exemplary embodiment, the CPU 105 sequentially performs the plurality kinds of page control processing on the variable graphics according to the contents set beforehand by a user. However, it may not be easy for a user to determine a page control processing item to be prioritized to efficiently eliminate the overlap between the variable graphics and other graphics. Therefore, the user may set an inefficient order for the items to be executed on the variable graphics in the page control processing.

Therefore, in the present exemplary embodiment, the CPU 105 compares differences in change amount as well as in overlap amount between a case where the page control processing is executed according to an order having been set beforehand and a case where the page control processing is executed according to an order that prioritizes a page control processing item that can realize a large change of the variable graphics. In the present exemplary embodiment, the change amount of the variable graphics is, for example, the change amount 1402 illustrated in FIG. 14, the reduction amount 1602 illustrated in FIG. 16, the movement amount 1802 illustrated in FIG. 18, the difference 2002 illustrated in FIG. 20, and the reduction amount 2105 illustrated in FIG. 22.

Then, based on a comparison result, the CPU 105 performs page control processing according to the order that can realize a smaller deviation relative to the overlap amount between the variable graphics and other graphics. Thus, the present exemplary embodiment is different from the above-described first exemplary embodiment in the processing for determining the order in the page control processing. Accordingly, in the description of the present exemplary embodiment, portions identical to or similar to those described in the first exemplary embodiment are denoted by the same reference numerals used in FIG. 1 to FIG. 22 and the detailed description for these portions are not repeated.

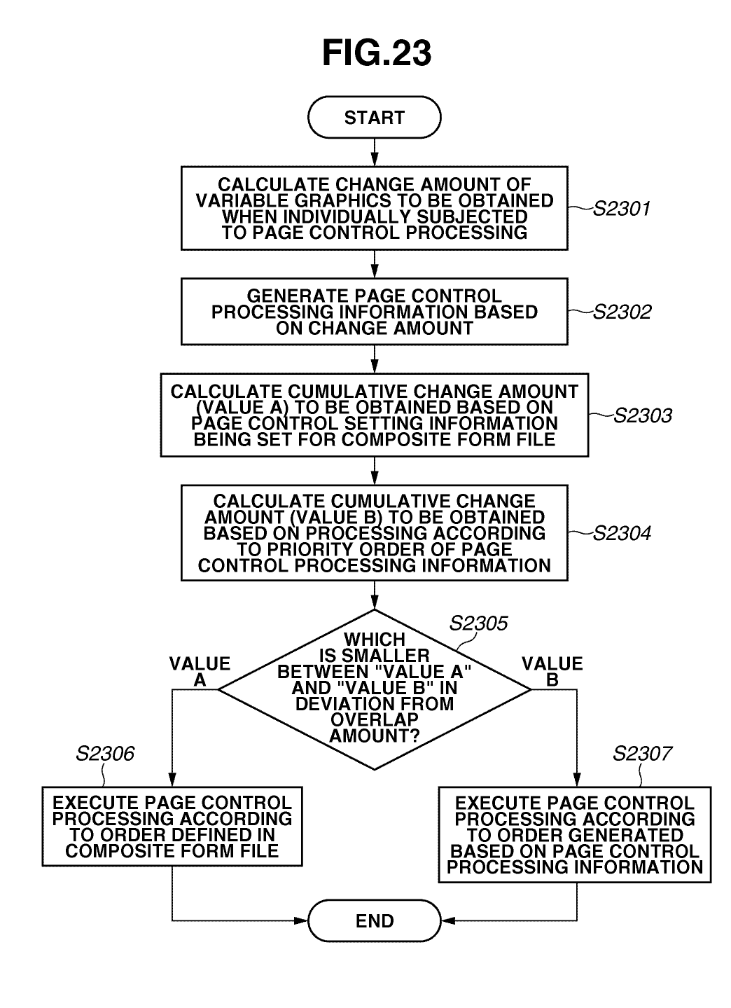

FIG. 23 is a flowchart illustrating an example of processing to be performed by the overlay printing system 301 that automatically performs the page control processing according to an optimum priority order in the page control processing, which is determined based on the overlap amount between the variable graphics and other graphics. The processing illustrated in FIG. 23 can be automatically executed as part of the overlay print processing of step S1116 illustrated in FIG. 11.

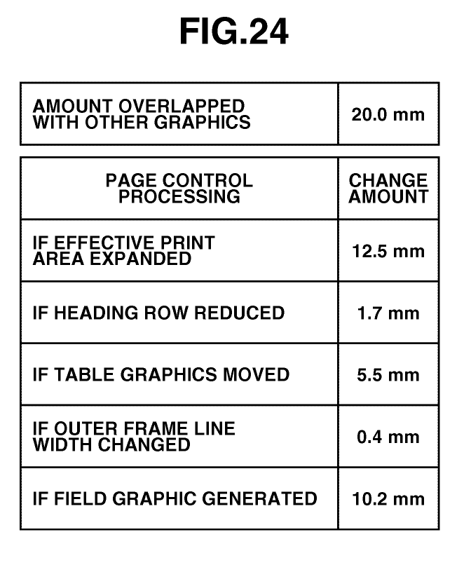

First, in step S2301, the CPU 105 calculates a “change amount of the variable graphics” to be obtained when individual page control processing is performed on the variable graphics. The change amounts calculated in step S2301 are stored in the CS 106 illustrated in FIG. 1. FIG. 24 illustrates an example of the change amounts calculated in step S2301 of FIG. 23. The change amounts obtained by performing the individual page control processing are, as described above, the change amount 1402 illustrated in FIG. 14, the reduction amount 1602 illustrated in FIG. 16, the movement amount 1802 illustrated in FIG. 18, the difference 2002 illustrated in FIG. 20, and the reduction amount 2105 illustrated in FIG. 22. The CPU 105 can calculate these change amounts through processing similar to those in step S1305 illustrated in FIG. 13, step S1505 illustrated in FIG. 15, step S1705 illustrated in FIG. 17, step S1905 illustrated in FIG. 19, and step S2105 illustrated in FIG. 21.

Next, in step S2302, the CPU 105 generates page control processing information that includes a priority order for successively executing a plurality of page control processing items by prioritizing an item largest in the change amount calculated in step S2301 over the remaining non-processed items. Then, the CPU 105 compares the page control setting information for the variable graphics in the composite form file 208 with the page control processing information generated in step S2302. The page control setting information for the variable graphics in the composite form file 208 is information that includes the order of the page control processing items. The order of the page control processing items contained in the page control setting information can be determined beforehand when the page control processing is defined. For example, as described in the first exemplary embodiment, users are allowed to set the order of the page control processing items when the overlay printing is executed.

In step S2303, the CPU 105 accumulates change amounts of the variable graphics to be obtained when the page control processing items are executed according to the order defined as part of the page control setting information in the composite form file 208 until the accumulated change amount of the variable graphics exceeds the overlap amount between the variable graphics and other graphics. Thus, the CPU 105 obtains a cumulative change amount (value A).

Next, in step S2304, the CPU 105 accumulates change amounts of the variable graphics to be obtained when the page control processing items are executed according to the order defined in the page control processing information generated in step S2302 until the accumulated change amount of the variable graphics exceeds the overlap amount between the variable graphics and other graphics. Thus, the CPU 105 obtains a cumulative change amount (value B).

Next, in step S2305, the CPU 105 calculates differences of respective cumulative change amounts (i.e., the value A and the value B calculated in steps S2303 and S2304) in relation to the overlap amount between the variable graphics and other graphics. Then, the CPU 105 compares a deviation of the cumulative change amount (the value A) calculated in step S2303 relative to the overlap amount between the variable graphics and other graphics with a deviation of the cumulative change amount (the value B) calculated in step S2304 relative to the overlap amount between the variable graphics and other graphics. Then, in step S2305, the CPU 105 determines which is smaller between the value A and the value B in deviation relative to the overlap amount.

If it is determined that the cumulative change amount (the value A) calculated in step S2303 is smaller in deviation relative to the overlap amount between the variable graphics and other graphics, the CPU 105 performs the following processing. More specifically, in step S2306, the CPU 105 executes the page control processing according to the order defined as part of the page control setting information in the composite form file 208. On the other hand, if it is determined that the cumulative change amount (the value B) calculated in step S2304 is smaller in deviation relative to the overlap amount between the variable graphics and other graphics, the CPU 105 performs the following processing. More specifically, in step S2307, the CPU 105 executes the page control processing according to the order defined in the page control processing information generated in step S2302. The contents of the page control processing are similar to those illustrated in FIG. 13, FIG. 15, FIG. 17, FIG. 19, and FIG. 21. Subsequently, the CPU 105 terminates the processing of the flowchart illustrated in FIG. 23.

If in step S2305 it is determined that the cumulative change amount (the value A) calculated in step S2303 and the cumulative change amount (the value B) calculated in step S2304 are not different in deviation relative to the overlap amount between the variable graphics and other graphics, the CPU 105 performs the following processing. More specifically, for example, the processing proceeds to a predetermined step (i.e., step S2306 or step S2307).

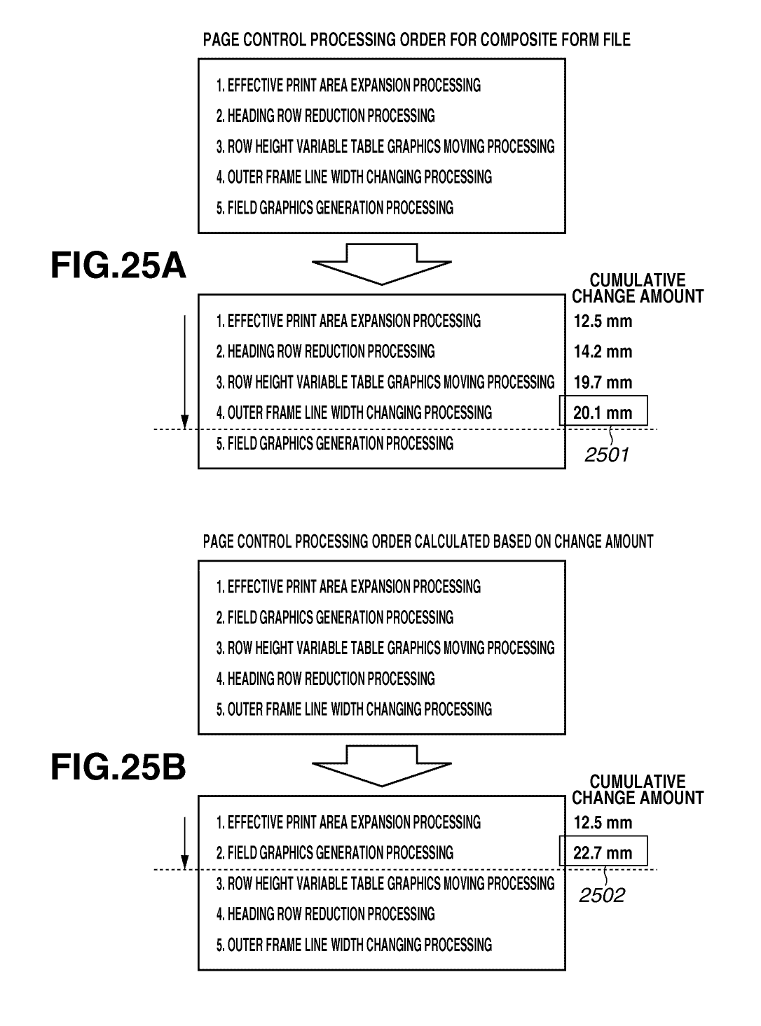

FIGS. 25A and 25B illustrate an example of a method for determining the order in the page control processing. FIG. 25A illustrates page control setting information (i.e., setting of priority order in the page control processing) for the variable graphics included in the composite form file 208. In this case, the CPU 105 performs the page control processing according to the priority order defined in the page control setting information. The CPU 105 performs the page control processing until the cumulative change amount obtained by executing each page control processing item exceeds the overlap amount between the variable graphics and other graphics. According to the example illustrated in FIG. 25A, a cumulative change amount 2501 (i.e., the cumulative change amount (the value A) calculated in step S2303) at the time when the CPU 105 has completed four kinds of page control processing items is 20.1 [mm].

On the other hand, FIG. 25B illustrates page control processing information (setting of priority order in the page control processing) according to which the page control processing item that can obtain a large change amount is ranked higher in the priority order. For example, the priority order in FIG. 25B can be determined with reference to the change amounts to be obtained by executing individual page control processing (see FIG. 24). In this case, the CPU 105 performs the page control processing according to the priority order defined in the page control processing information. The CPU 105 performs the page control processing until the cumulative change amount obtained by executing each page control processing item exceeds the overlap amount between the variable graphics and other graphics. According to the example illustrated in FIG. 25B, a cumulative change amount 2502 (i.e., the cumulative change amount (the value B) calculated in step S2304) at the time when the CPU 105 has completed two kinds of page control processing items is 22.7 [mm].

Then, if it is determined that the change amount between an overlay printing result and the original composite form configuration can be minimized, the CPU 105 finally executes the page control processing. According to the example illustrated in FIGS. 25A and 25B, the CPU 105 executes the page control processing for the variable graphics defined in the composite form file 208 to realize a desired change amount (i.e., the cumulative change amount 2501 or the cumulative change amount 2502) that is closer to the overlap amount between the variable graphics and other graphics.

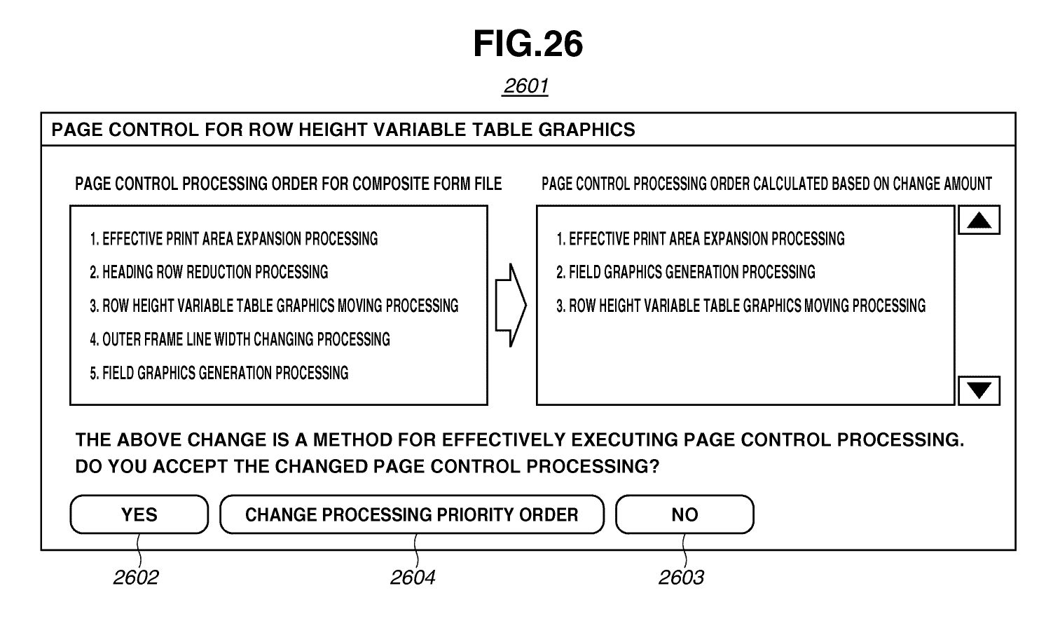

The above-described sequential processing can be applied not only to the overlay print processing but also to preview processing. FIG. 26 illustrates an example of the dialog that enables users to select page control processing items to be executed in the preview processing. A dialog 2601 indicates that the overlay printing can be efficiently accomplished if the page control processing is executed according to the order defined in the page control processing information rather than according to the order defined in the page control setting information of the composite form file 208.

If a button 2602 is pressed on the dialog 2601, the CPU 105 performs the preview display that reflects the page control processing to be executed according to the order defined in the page control processing information, and the CPU 105 performs the overlay printing according to the displayed contents. On the other hand, if a button 2603 is pressed on the dialog 2601, the CPU 105 performs the preview display that reflects the page control processing to be executed according to the order defined in the page control setting information in the composite form file 208, and the CPU 105 performs the overlay printing according to the displayed contents. Further, the dialog 2601 includes a button 2604 that enables users to freely change the order in the page control processing while viewing the contents of the dialog 2601.

As described above, in the present exemplary embodiment, the CPU 105 compares a difference between the change amount and the overlap amount in a case where the page control processing is executed according to the order having been set beforehand as well as in a case where the page control processing is executed according to the order that prioritizes the page control processing item that can realize a large change of the variable graphics. Then, the CPU 105 performs the page control processing according to the order that can realize a smaller deviation relative to the overlap amount between the variable graphics and other graphics. Accordingly, the present exemplary embodiment can automatically execute the page control processing effectively. Therefore, in addition to the effects described in the first exemplary embodiment, the present exemplary embodiment can greatly improve the efficiency of the overlay print processing.

As described above, the present exemplary embodiment compares the case where the page control processing is executed according to the order having been set beforehand and the case where the page control processing is executed according to the order that prioritizes the page control processing item that can realize a large change of the variable graphics. However, the present invention is not limited to the above-described embodiments. More specifically, instead of performing the above-described comparison, the CPU 105 can automatically (unconditionally) performs the page control processing for each cumulative change amount calculation object according to the order that prioritizes the page control processing item that can realize a large change of the variable graphics.

In the above-described exemplary embodiments, the CPU 105 performs control for eliminating any overlap of a component form image with other image that may occur in the height direction (i.e., in the vertical expansion direction of the variable graphics). However, the direction for eliminating the overlap between the images is not limited to the height direction of the images. For example, the CPU 105 can perform control for eliminating any overlap of the component form image with another image in the horizontal direction in a case where the expansion direction of the variable graphics is the horizontal direction.

Further, in the above-described exemplary embodiments, the CPU 105 performs the following page control processing items.

(1) The processing for expanding the effective print area of the sheet in the expansion direction of the variable graphics.
(2) The processing for reducing the height of the heading row of the variable graphics.
(3) The processing for moving the graphic position of the variable graphics by an amount that does not cause any overlap with other graphics.
(4) The processing for changing the line width of the outer frame line of the variable graphics.
(5) The processing for replacing the data in the enlarged portion where the row height becomes larger than the original row height with other data having a smaller data size that can be accommodated in the original row height and generating field graphics for storing the original data.

However, the page control processing is not limited to the above-described contents as far as a layout result of the field data can be changed in such a way as to eliminate the overlap between the variable graphics and other graphics by changing at least one of the attribute of the field data and the attribute of the form. For example, in addition to or instead of the heading row of the variable graphics, the CPU 105 can reduce the height of another row. For example, the CPU 105 can uniformly reduce the height of each row of the variable graphics. Further, the CPU 105 can reduce the line width of a “line extending in a direction perpendicular to the expansion direction of the variable graphics (i.e., the horizontal direction according to the above-described exemplary embodiments)” other than the outer frame line. In the context of the present specification, the term “layout” indicates a display pattern that relates to any one of the position and the size of the field data form.

To realize each unit of the information processing apparatus and each step of the image data generation method according to the above-described exemplary embodiments of the present invention, a computer can execute a software program stored in a random access memory (RAM) or a read only memory (ROM). The present invention encompasses the above-described program and a computer-readable storage medium that stores the program.

Further, the present invention can be realized, for example, as a system, an apparatus, a method, a program, or a storage medium. More specifically, the present invention can be applied to a system including a plurality of devices or can be applied to an apparatus constituted by a single device. A storage medium storing software program code for realizing the functions of the above-described exemplary embodiments can be supplied to a system or an apparatus. A computer (or CPU or micro-processing unit (MPU)) in the system or the apparatus can execute the program code to realize the functions of the above-described exemplary embodiments.

In this case, the program code itself read out of the storage medium can realize the functions of the above-described exemplary embodiments. The storage medium storing the program code constitutes the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-056757 filed Mar. 10, 2009, which is hereby incorporated by reference herein in its entirety.

What is claimed is:

1. An information processing apparatus comprising:
a generation unit configured to generate a composite form based on a plurality of component forms so as to include at least one component form that can be combined with field data;
a combining unit configured to combine field data with the component form;
a first change unit configured to change a size of the component form that accommodates the field data combined based on the field data;
a calculation unit configured to, in a case where the size of the component form is changed and the changed component form is overlapped with any one of the plurality of component forms included in the composite form, calculate a change amount in a layout of the composite form to be realized according to each method if there are a plurality of methods for changing the layout in such a way as to eliminate the overlap;
a determination unit configured to select a method to be executed among the plurality of methods based on the change amount; and
a second change unit configured to change the layout of the composite form obtained by the combining unit in such a way as to eliminate the overlap by executing the selected method.

2. The information processing apparatus according to claim 1, further comprising:
an overlap amount calculation unit configured to calculate an overlap amount of the overlap; and
a cumulative value calculation unit configured to calculate a cumulative change amount based on the calculated change amount when at least one of the plurality of methods is executed, until the calculated cumulative change amount exceeds the overlap amount,
wherein the determination unit is configured to designate one of the methods used for calculating the cumulative value, as the method to be executed among the plurality of methods.

3. The information processing apparatus according to claim 2, wherein the cumulative value calculation unit is configured to calculate the cumulative value according to an order that prioritizes a method capable of realizing a large change amount over the rest of the plurality of methods.

4. The information processing apparatus according to claim 2, wherein the cumulative value calculation unit is configured to calculate a first cumulative value according to an order that prioritizes a method capable of realizing a large change amount over the rest of the plurality of methods and further calculate a second cumulative value according to an order determined beforehand for the plurality of methods, and
wherein the determination unit is configured to designate one of the methods used for calculating a smaller cumulative value between the first cumulative value and the second cumulative value, as the method to be executed.

5. The information processing apparatus according to claim 1, wherein the plurality of methods includes at least one of a method for expanding an effective print area of the composite form, a method for changing a height of a heading row included in the component form, a method for moving the component form, a method for changing a line width of an outer frame line of the component form, and a method for generating a component form based on the field data without combining the field data with the component form and combining the generated component form with the composite form.

6. The information processing apparatus according to claim 1, wherein the component form that can be combined with the field data includes table graphics.

7. The information processing apparatus according to claim 1, wherein the plurality of component forms includes at least one of stationary characters and stationary graphics.

8. An information processing apparatus comprising:
a generation unit configured to generate a composite form based on a plurality of component forms so as to include at least one component form that can be combined with field data;
a combining unit configured to combine field data with the component form;
a first change unit configured to change a size of the component form that accommodates the field data combined based on the field data; and
a second change unit configured to, in a case where the size of the component form is changed and the changed component form is overlapped with any one of the plurality of component forms included in the composite form, change a layout result of the field data by changing at least one of an attribute of the field data and an attribute of the composite form, so as to eliminate the overlap.

9. An image data generation method comprising:
generating a composite form based on a plurality of component forms so as to include at least one component form that can be combined with field data;
combining field data with the component form that can be combined with the field data;
changing a size of the component form that accommodates the combined field data based on the field data;
in a case where the size of the component form is changed and the changed component form is overlapped with any one of the plurality of component forms included in the composite form, calculating a change amount in a layout to be realized according to each method if there are a plurality of methods for changing the layout of the composite form in such a way as to eliminate the overlap;
selecting a method to be executed among the plurality of methods based on the calculated change amount; and
changing the layout of the composite form in such a way as to eliminate the overlap by executing the selected method.

10. The image data generation method according to claim 9, further comprising:
calculating an overlap amount of the overlap;
calculating a cumulative change amount based on the calculated change amount when at least one of the plurality of methods is executed, until the calculated cumulative change amount exceeds the overlap amount; and
designating one of the methods used for calculating the cumulative value, as the method to be executed among the plurality of methods.

11. The image data generation method according to claim 10, further comprising:
calculating the cumulative value according to an order that prioritizes a method capable of realizing a large change amount over the rest of the plurality of methods.

12. The image data generation method according to claim 10, further comprising:
calculating a first cumulative value according to an order that prioritizes a method capable of realizing a large change amount over the rest of the plurality of methods and further calculating a second cumulative value according to an order determined beforehand for the plurality of methods; and
designating one of the methods used for calculating a smaller cumulative value between the first cumulative value and the second cumulative value, as the method to be executed.

13. The image data generation method according to claim 9, wherein the plurality of methods includes at least one of a method for expanding an effective print area of the composite form, a method for changing a height of a heading row included in the component form, a method for moving the component form, a method for changing a line width of an outer frame line of the component form, and a method for generating a component form based on the field data without combining the field data with the component form and combining the generated component form with the composite form.

14. The image data generation method according to claim 9, wherein the component form that can be combined with the field data includes table graphics.

15. The image data generation method according to claim 9, wherein the plurality of component forms includes at least one of stationary characters and stationary graphics.

16. An image data generation method comprising:
generating a composite form based on a plurality of component forms so as to include at least one component form that can be combined with field data;
combining field data with the component form that can be combined with the field data;
changing a size of the component form that accommodates the combined field data, based on the field data; and
in a case where a size of a component form is changed and the changed component form is overlapped with any one of the plurality of component forms included in the composite form, changing a layout result of the field data by changing at least one of an attribute of the field data and an attribute of the composite form, so as to eliminate the overlap.

17. A computer-readable storage medium storing a program for causing a computer to perform image data generation processing, the program comprising:
computer-executable instructions for generating a composite form based on a plurality of component forms so as to include at least one component form that can be combined with field data;
computer-executable instructions for combining field data with the component form that can be combined with the field data;
computer-executable instructions for changing a size of the component form that accommodates the combined field data based on the field data;
computer-executable instructions for, in a case where a size of a component form is changed and the changed component form is overlapped with any one of the plurality of component forms included in the composite form, calculating a change amount in a layout of the composite form to be realized according to each method if there are a plurality of methods for changing the layout of the composite form in such a way as to eliminate the overlap;
computer-executable instructions for selecting a method to be executed among the plurality of methods based on the calculated change amount; and
computer-executable instructions for changing the layout of the composite form in such a way as to eliminate the overlap by executing the selected method.

18. The computer-readable storage medium according to claim 17, further comprising:
calculating an overlap amount of the overlap;
calculating a cumulative change amount based on the calculated change amount when at least one of the plurality of methods is executed, until the calculated cumulative change amount exceeds the overlap amount; and
designating one of the methods used for calculating the cumulative value, as the method to be executed among the plurality of methods.

19. The computer-readable storage medium according to claim 18, further comprising:
calculating the cumulative value according to an order that prioritizes a method capable of realizing a large change amount over the rest of the plurality of methods.

20. The computer-readable storage medium according to claim 18, further comprising:
calculating a first cumulative value according to an order that prioritizes a method capable of realizing a large change amount over the rest of the plurality of methods and further calculating a second cumulative value according to an order determined beforehand for the plurality of methods; and
designating one of the methods used for calculating a smaller cumulative value between the first cumulative value and the second cumulative value, as the method to be executed.
